(19) United States
(12) Patent Application Publication
(10) Pub. No.: US 2002/0005826 A1
(43) Pub. Date: Jan. 17, 2002

(54) LED sign

(76) Inventor: John C. Pederson, St. Cloud, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 09/858,339

(22) Filed: May 15, 2001

Related U.S. Application Data
(60) Provisional application No. 60/204,612, filed on May 16, 2000.
(60) Provisional application No. 60/248,894, filed on Nov. 15, 2000.

(51) Int. Cl. G09G 3/32

(52) U.S. Cl. 345/82

(57) ABSTRACT

A system for displaying an image comprising at least one display apparatus. Each display apparatus including at least one light bar having a plurality of light emitting diodes mounted thereto. At least one support joining each light bar to a rotation mechanism. The rotation mechanism being constructed and arranged to rotate the light bars at a predetermined rate of rotation. The system also includes a controller in electrical communication with each of the plurality of light emitting diodes, and the rotation mechanism of each of the at least one display apparatus. The controller constructed and arranged to control the predetermined rate of rotation and selectively activate the light emitting diodes to produce at least one image capable of being perceived by a viewer.

### CROSS-REFERENCE TO RELATED APPLICATIONS

This application claims priority from U.S. provisional application No. 60/204,612, filed May 16, 2000, the entire contents of which are incorporated herein by reference. This application also claims priority from U.S. Provisional application No. 60/248,894, filed Nov. 15, 2000. The entire contents of which are incorporated herein by reference.

### STATEMENT REGARDING FEDERALLY SPONSORED RESEARCH

Not Applicable

### BACKGROUND OF THE INVENTION

1. Field of the Invention

The present invention is directed to an apparatus having a plurality of multi-colored light emitting diodes (LEDs) arranged on one or more vertically extending arms or light sticks. The light sticks are mounted on one or more supports which are dispersed about a rotation point. The apparatus includes a controller which is constructed and arranged to selectively control the speed of rotation of the support(s) as well as the illumination of the individual LEDs positioned within each vertically extending arm. The controller provides for selective rotation of the support and illumination of the LED'S to create an active visual display which displays a given image or message, the image may vary depending on a viewer's angular displacement, or perspective from the apparatus. The controller further includes one or more input devices for receiving reprogramming information for altering the image(s) created by the rotating display. Reprogramming instructions may be transmitted directly or by free space pulsed light signal transmissions.

2. Description of the Related Art

Light displays such as flat panel signs, billboards, store fronts, car roof displays and other types of displays often typically utilize lights to produce a variety of lighting effects. For instance displays such as billboards commonly have incandescent lights to illuminate the billboard surface from below and/or may utilize florescent lights to illuminate the sign from above. Such displays or signs are limited in that they may be seen from essentially only one direction. Other signs may include a translucent front and back with an internal lighting to allow the image depicted on the sign to be seen from two or more points of view. Signs such as those described thus far are also know to include rotation mechanisms which allow the signs to be seen from any angle over a predetermined period of time.

As lighting technology has advanced so to has the complexity and effectiveness of illuminated signs. Newer displays may include one or more panels of light sources which may be selectively illuminated to provide a viewer with a variety of images and text based messages. For instance many banks have invested in display signs which provide a viewer with information such as interest rates, the current time, the temperature, etc. The information may change and the sign itself may be rotated to simultaneously provide different information to different viewers having different observation perspectives.

Despite advances in display effectiveness such as described above, several short-comings continue to exist in the illuminated display art. It is desirable to provide a display apparatus which is capable of producing one or more images which may be produced and viewed simultaneously in a 360 degree viewing arc. It is also desirable to simultaneously produce different images depending on the angle to which the display is viewed. It would be further beneficial to provide such a display with a high degree of portability, as well as the capacity for vehicle mounting. Furthermore, it would be desirable to provide such a display apparatus with the capability of being utilized with any number of other displays in combination to provide an aggregate composite display capable of producing an even greater variety of images and image effects.

In addition to the deficiencies listed above, many common light sources are being used in known lighting displays such as halogen lamps, gaseous discharge xenon lamps, neon lights, and many other types of light sources or lamps. These types of lamps emit significant quantities of heat which may be difficult to dissipate from a sealed display, sign or fixture and may damage electronic circuitry contained therein. In addition, these lamps consume large amounts of current requiring a large power supply, battery or electrical source. These lamps also generate substantial electromagnetic emissions which may interfere with radio communications, which may be especially problematic in vehicle mounted lamps and displays. Finally, these lamps, are typically not rugged and generally have a relatively short operational life necessitating frequent replacement.

In view of the above, there is a need for a light display that: (1) is capable of producing one or more illuminated images viewable from one or more predetermined positions; (2) produces a predetermined number of images with at least one different image in each of a predetermined number of viewable sectors ; (3) generates little heat; (4) uses substantially less electrical current; (5) produces significantly reduced amounts of electromagnetic emissions; (6) is rugged and has a long life span; (7) is portable; (8) produces a truer light output color without the use of filters; (9) reduces current draw upon a vehicle power supply; (10) is positionable at a variety of locations about a vehicle; and (11) which may be used in conjunction with other light displays to produce a wide variety of images and light effects which may or may not vary depending on a viewer's perspective.

Another problem with the known signs is the use of filters to produce a desired color. Filtering techniques produce more heat that must be dissipated. Moreover, changing the color of a light source requires the physical removal of the filter from the light source and the replacement of a new filter. Furthermore, filters fade or flake over time rendering the filters unable to consistently produce a desired color for observation in an emergency situation.

These problems associated with traditional signs are exacerbated by the fact that creating multiple light signals or images may require multiple signs. Further, there is little flexibility in modifying an existing sign which may be cost prohibitive.

A need exists to enhance the durability of a lighted sign and to reduce the failure rate of illumination devices while simultaneously reducing the cost of a replacement illumination source.

In addition the known signs incorporate mechanical devices and light sources which in combination frequently require a relatively large power source to impart rotational and/or oscillating movement for the sign.

The known signs also fail to have flexibility for the provision of variable intensity for the sign light sources. The number of available distinct and independent visual light effects is therefore limited. In certain situations it may be desirable to provide variable intensity for a light signal within a sign, or a modulated light intensity for a light source within a sign, to provide a unique light effect to facilitate observation by an individual. In addition, the provision of a variable or modulated power intensity for a light source within a sign may further enhance the ability to provide a unique desired light effect for observation by an individual.

No signs are known which also incorporate an LED sign used to provide irregular or random light intensity to establish a desired lighting effect.

No signs are known which enable alteration of a light signal through remote manipulation or activation. Remote control of a sign is generally undesirable because radio frequency transmitters and receivers are generally costly and require a large power supply which is a concern for motor vehicles.

No signs are known which include features for optic communication and features for the generation of a visual image.

The free space pulsed light signals, may also be referred to as variable and/or pulsed light signals identified as the systematic information transfer through encrypted/pulsed light or acronym SIT-TEL. Further, it has not been know to use a variable and/or pulsating light signal or SIT-TEL communications as generated from a sign through the use of LED technology.

In addition, no sign is known which may utilize a light signal for detection by a receiver which may then trigger pre-stored images or convert information from a received signal to a visual image.

Currently each year a significant number of automobiles and other motor vehicles are involved in accidents areas which are not marked with warning bells, and/or flashing light signals. The absence of warning devices is frequently the result of economic considerations at remote and/or low traffic areas. A need exists for a warning sign at remote areas including railroad crossings which may be easily attached to an existing structure or and/or be free standing.

No sign is presently known which may be used as a warning signal at railroad crossing locations which provides a low cost, bright visual light signal which is durable and which operates on low current through battery and/or solar generated power.

### GENERAL DESCRIPTION OF THE INVENTION

According to the invention, there is provided a light emitting diode (LED) sign having capabilities to generate a warning signal light and SIT-TEL pulsed light communication system which may be depicted in several embodiments. In general, the LED sign and SIT-TEL pulsed light communication system may be formed of a single row, single source, or an array of light emitting diode light sources configured on a light support and in electrical communication with a controller and a power supply, battery, or other electrical source. The LED sign and SIT-TEL pulsed light communication system may provide various images, light signals, colored light signals, or combination light signals. These images or light signals may include images, characters, messages, a strobe light, a pulsating light, a revolving light, a flashing light, a modulated or variable intensity light, an oscillating light, an alternating light, an encoded signal, and/or various patterns or combinations thereof. SIT-TEL pulsed light communication system and LED sign may also be transportable and may be conveniently connected to a stand such as a tripod for electrical connection to a power supply, battery, or other electrical source as a remote stand-alone signaling or communication device.

The LED sign and SIT-TEL pulsed light communication system may be electrically coupled to a controller which is used to vary, modulate, pulse, or encode the power intensity for the LED light sources to provide for various patterns of illumination to create an image, message or signal.

The controller of the LED sign is preferably in electrical communication with the power supply and the LED's to modulate the power intensity for the LED light sources for provision of a desired type of image, light effect, or encoded SIT-TEL pulsed light communication signal.

The LED sign may be formed of an array of LED's, a single row of LED's or a solitary LED mounted upon and in electrical communication with a substantially flat light support which includes a circuit board or LED mounting surface.

The SIT-TEL LED light system as a portion of the LED sign may also include a receptor coupled to the controller where the receptor is constructed and arranged for receipt of pulsed SIT-TEL LED light signals for conversion to digital information for transfer to the controller for analysis and interpretation. The controller may then illuminate an image, message, or character to provide a light signal.

The controller is preferably constructed and arranged for regulating the rotation of the sign, the flashing of one or more LED'S or combinations of LED's, as well as the provision of a modulated, variable, and/or pulsed SIT-TEL light signal to be received and recognized by a second receptor located on a second light support which may be mounted to a vehicle. A response SIT-TEL LED pulsed light signal may be generated by the second light support to be received by the first receptor as connected to the LED sign. The responsive pulsed SIT-TEL LED light signal as transmitted from the second light support may include a series of unique signal packets representative of information to be transmitted. The controller on the LED sign upon receipt of the transmitted packets of pulsed light initiates a processing procedure for the signal received by the first receptor, which may be compared to a data base for display of information on a visible screen. The SIT-TEL LED light signal system of an LED sign may be used for interrogation of a license plate during law enforcement activities.

The controller of the LED sign may initiate the transmission of a responsive SIT-TEL pulsed LED light signal which may include a desired type of information.

A principal advantage of the present invention is that the LED sign is capable of producing several different types, patterns and/or combinations of light signals, images, characters and/or messages.

Another principal advantage of the present invention is to be rugged and to have a relatively longer life cycle than traditional signs.

Still another principal advantage of the present invention is to produce a truer or pure light output color for a sign without the use of filters.

Still another principal advantage of the present invention is to allow the user to adjust the color of the image, character and/or message without having to make a physical adjustment to the LED sign.

Still another principal advantage of the present invention is that it may be formed into various sizes. This allows the invention to be customized for the particular need.

Still another principal advantage of the present invention is the provision of an LED sign which is formed of a relatively simple and inexpensive design, construction, and operation and which fulfills the intended purpose without fear of failure or risk of injury to persons and/or damage to property.

Still another principal advantage of the present invention is the provision of an LED sign which has an extended life cycle and continues to operate at maximum efficiency throughout its life cycle.

Still another principal advantage of the present invention is the provision of an LED sign which draws less current and/or has a reduced power requirement from a power source.

Still another principal advantage of the present invention is the provision of an LED sign which functions under cooler operating temperatures and conditions thereby minimizing the exposure of heat to adjacent component parts which, in turn, reduces damage caused by excessive heat.

Still another principal advantage of the present invention is the provision of a LED sign which may be easily visualized.

Still another principal advantage of the present invention is the provision of a LED sign which includes LED technology and which is operated by a controller to provide any desired type, combination, pattern or color of image, message and/or character which may include but is not necessarily limited to rotational, pulsating, oscillating, strobe, flashing, alternating, variable and/or modulated light signals.

Still another principal advantage of the present invention is the provision of a LED sign which includes light emitting diode technology which is flexible and which may be positioned at any desired location about the exterior of a vehicle.

Still another principal advantage of the present invention is the provision of an LED sign for a vehicle which has improved visualization and aerodynamic efficiency.

Still another principal advantage of the present invention is the provision of an LED sign having improved flexibility for providing alternative and unique light signals or lighting effects.

Still another principal advantage of the present invention is the provision of a LED sign and/or SIT-TEL pulsed light LED communication system which may be easily customized by the user via the use of a microprocessor/controller.

Still another principal advantage of the present invention is that the LED sign includes a controller which is constructed and arranged to generate a series of SIT-TEL pulsed light signal packets where each packet includes a recognizable set of information.

Still another principal advantage of the present is that the LED sign includes a receptor which is capable of receipt and recognition of pulsed SIT-TEL LED light signal packets for translation and/or transfer to a controller for processing.

Still another principal advantage of the present invention is that the controller of the LED sign is constructed and arranged to interpret and process received SIT-TEL LED pulsed light signal packets for processing and generation of a response series of pulsed SIT-TEL LED light signals and/or packets to carry information to a second receptor.

Still another principal advantage of the present invention is the provision of a SIT-TEL LED communication system for an LED sign which may be used to interrogate a license plate for communication of information.

Yet another advantage of the invention is the provision of an LED support arm including colored LED's and a base or hub having a controller capable of selectively illuminating the LED's of the same or different colors to produce a single or mixed colored image or light signal.

Still another advantage of the invention is the provision of a light emitting diode support arm having LED's disposed about one or more sides of a support arm and a controller capable of producing light signals on each side which are independent and/or different from each other.

Still another advantage of the invention is the provision of an LED support arm which may have one or more LED's angularly offset with respect to the LED support arm for the provision of a horizontal light signal as viewed by an individual.

Still another advantage of the invention is the provision of an LED support arm which may be easily connectable and/or removed from a transportable support for placement of an LED sign at any location as desired by an individual.

Still another advantage of the present invention is the provision of an LED sign where the circuit board or LED mounting surface includes one or more heat sink wells where an individual LED is positioned within each of the heat sink wells.

Still another advantage of the present invention is the provision of an LED sign having a culminator reflector which may be formed of one or more conical reflector cups which are utilized to reflect light emitted from the light sources in a direction desired by an individual.

Still another advantage of the present invention is the provision of a SIT-TEL LED pulsating light system of an LED sign having a controller having a processor programmed for the performance of a handshake protocol during the transmission and/or receipt of a pulsed light signal used to communicate information.

Still another advantage of the present invention is the provision of a SIT-TEL LED pulsating light system of an LED sign which may generate a pulsed light signal over a wide variety of light wavelengths.

Still another advantage of the present invention is the provision of a SIT-TEL LED pulsating light system for an LED sign having a selection mechanism permitting convenient alteration of frequencies or wavelengths of transmitted and/or received pulsated light signals.

Still another advantage of the present invention is the provision of a SIT-TEL LED pulsating light system of an LED sign having a scanner for automatic searches for identification of transmissions of pulsated light signals generated at varying wavelengths and/or frequencies.

Still another advantage of the present invention is the provision of a SIT-TEL LED pulsating light system of an LED sign having a selection switch to regulate the provision of a focused directional pulsed light signal or a nondirectional pulsed light signal.

Still another advantage of the present invention is the provision of a SIT-TEL LED pulsating light system of an LED sign including a modulating light source which may emit 20 to 60 cycles of light signals per minute.

Still another advantage of the present invention is the provision of a SIT-TEL LED pulsating light system of an LED sign providing modulated pulsating light at a frequency of 80 Hz or higher.

Still another advantage of the present invention is the provision of a SIT-TEL LED pulsating light system of an LED sign which may transmit an encrypted pulsated LED light signal.

Still another advantage of the present invention is the provision of a SIT-TEL pulsating LED light system of an LED sign which may transmit a pulsed LED light signal in the visible and non-visible spectrum.

### BRIEF DESCRIPTION OF THE INVENTION

This invention provides for a visual display system. The present system may include one or more rotating displays which are capable of forming one or more visually perceivable images. The images are formed by selectively illuminating LEDs mounted to one or more vertically projecting light bar, arms, or sticks of the rotating displays. The apparatus includes a controller which controls, on an individual and collective basis, each display comprising the system. The controller controls the rotation of the individual display's light bars around their respective common rotation axis and selectively illuminates one or more of the LEDs. The controller will typically include a software package executed by a computer. The controller may also be integral to the device, and may be capable of receiving reprogramming instructions from a remote transmitter unit through free space pulsed light signals. The controller may also provide the apparatus with the ability to form different images or messages depending on a viewer's angular displacement or perspective angle relative to the display system. One or more different images or messages may be displayed simultaneously, or at different points in time, which may be perceived only when viewed at certain angles, at all angles, or any combination thereof. The individual displays may be configured in a wide range of sizes, may be physically linked together, may be collapsible for transport, and may be vehicle mounted.

### BRIEF DESCRIPTION OF THE SEVERAL VIEWS OF THE DRAWINGS

A detailed description of the invention is hereafter described with specific reference being made to the drawings in which:

FIG. 1 is a perspective view of an embodiment of the invention wherein a single display is equipped with a single arm and single column of light sources.

FIG. 2 is a perspective view of an embodiment of the invention wherein a single display is equipped with a plurality of arms and columns of light sources.

FIG. 3 is a perspective view of an embodiment of the inventive display system which includes a plurality of multi-armed displays arranged in a circular pattern.

FIG. 4 is a perspective view of another embodiment of the inventive display system which includes a plurality of multi-armed displays arranged in a linear arrangement.

FIG. 5 is a perspective view of another embodiment of the inventive display system which includes a plurality of multi-armed displays arranged in both a linear and circular pattern.

FIG. 6 is a close-up perspective view of an individual light emitting diode and associated housing.

FIG. 7 is perspective view of another embodiment of a single display system wherein the arms are angled toward the top of the display.

FIG. 8 is a schematic depiction of the various elements of an embodiment of the invention.

FIG. 9 is a schematic depiction of the various elements of an alternative embodiment of the invention.

FIG. 10 is a schematic depiction of the various elements of an alternative embodiment of the invention.

FIG. 11 is a schematic depiction of the various elements of an alternative embodiment of the invention.

FIG. 12 is an illustration depicting some potential uses of embodiments of the present invention.

FIG. 13 is a perspective view of an alternative embodiment of the invention wherein a two display system is shown mounted on a trailer.

FIG. 14 is an alternative perspective, partially exploded view of an embodiment to the invention wherein LED'S are provided on more than one side of a mounting arm.

FIG. 15 is a detailed isometric view of a culminator cup.

FIG. 16 is an isometric cross-sectional side view of a culminator cup.

FIG. 17 is an alternative cross-sectional side view of a culminator cup.

FIG. 18 is an alternative cross-sectional side view of a culminator cup.

FIG. 19 is an exploded isometric view of an alternative culminator assembly and mounting arm.

FIG. 20 is an alternative partial cutaway isometric view of an alternative culminator assembly and mounting arm.

FIG. 21 is a block diagram of an electrical schematic of an embodiment of the invention.

FIG. 22 is a block diagram of an electrical schematic of an embodiment of the invention.

FIG. 23 is a block diagram of an electrical schematic of an embodiment of the invention.

FIG. 24 is a block diagram of an electrical schematic of an embodiment of the invention.

FIG. 25 is a block diagram of a controller, transmitter, and receiver of a SIT-TEL LED pulsating light signal system.

FIG. 26 is an environmental view of a license plate SIT-TEL LED pulsating light signal system.

FIG. 27 is an environmental view of the operation of the SIT-TEL pulsed light signaling system.

FIG. 28 is an environmental view of the operation of the SIT-TEL pulsed light signaling system and bus.

FIG. 29 is an environmental view of an external controller reprogramming an internal controller.

FIG. 30 is an isometric detail view of an external controller.

FIG. 31 is a perspective view of an external controller and central processing unit.

### DETAILED DESCRIPTION OF THE INVENTION

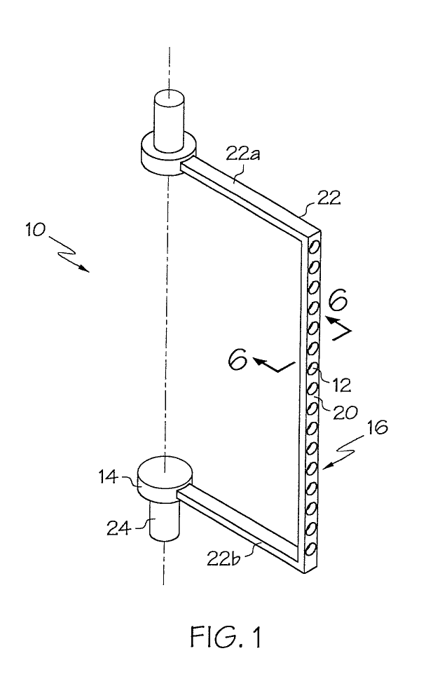

Turning now to a detailed description of a number of preferred embodiments of the present invention, FIG. 1 illustrates an embodiment of the light emitting diode (LED) display, indicated generally at 10. The LED display 10 is capable of creating a variety of visual effects including the formation of images such as text characters, holographic images, as well as other types of images. The images are created by selectively activating and/or flashing a plurality of LEDs 12 which are mounted in a column on a visible surface of a mounting arm 16 while the LEDs 12 are being rotated about a rotation hub 14. The arm 16 is rotated with a sufficient rotational velocity to allow a viewer's persistence of vision to perceive the image formed by the selectively illuminated LEDs 12.

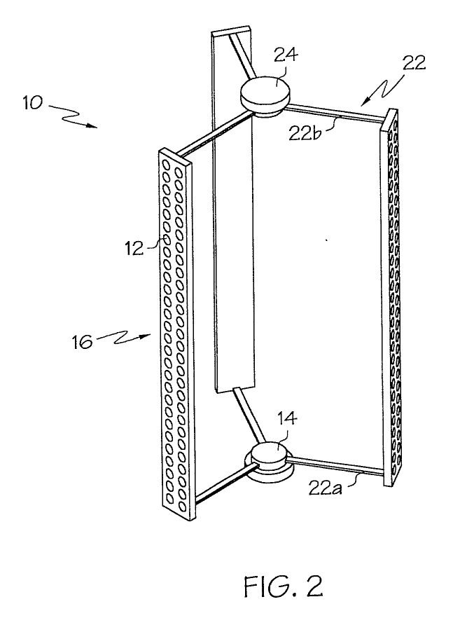

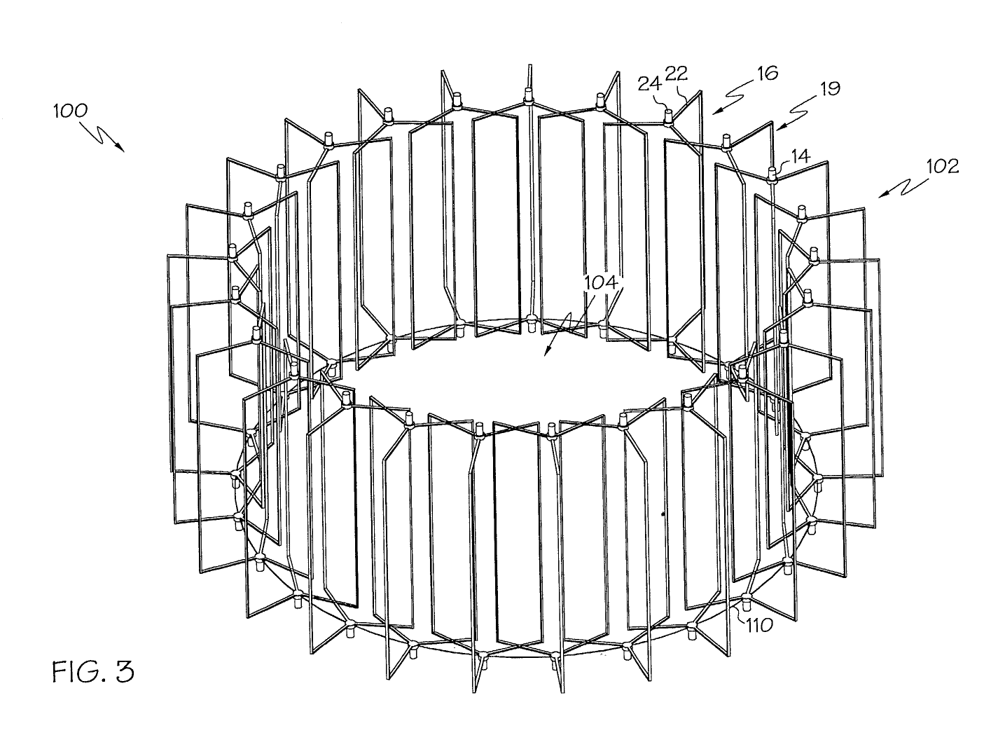

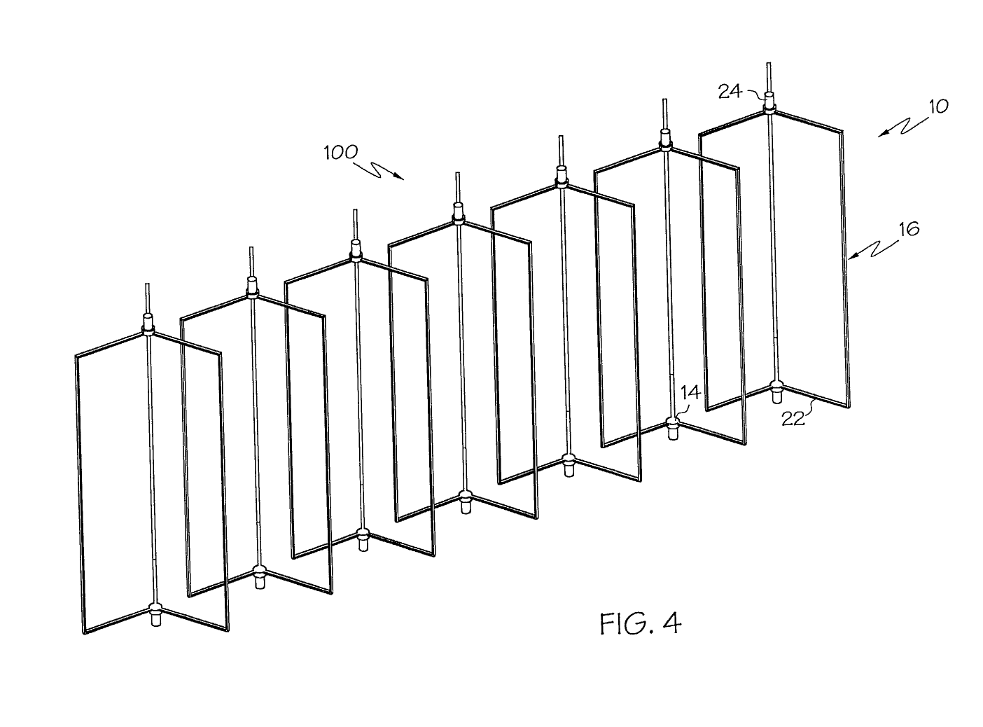

The display system 10 of the present invention may be provided in a wide variety of configurations. For example in the embodiment shown in FIG. 1, a single display apparatus 10 which has a single light arm 16 and a single column of LEDs 12 is shown. In an alternative embodiment shown in FIG. 2, the display 10 includes a plurality of arms 16 wherein at least one of the arms 16 is equipped with multiple columns and rows of LEDs 12. In still other embodiments shown in FIGS. 3-5, multiple displays 10 are combined together to form unique combination display systems indicated generally at 100. Clearly, other configurations in addition to those set forth herein are possible. It must therefore be noted that the present invention is directed to any rotational visual display system having any configuration and number of displays, arms, and LEDs.

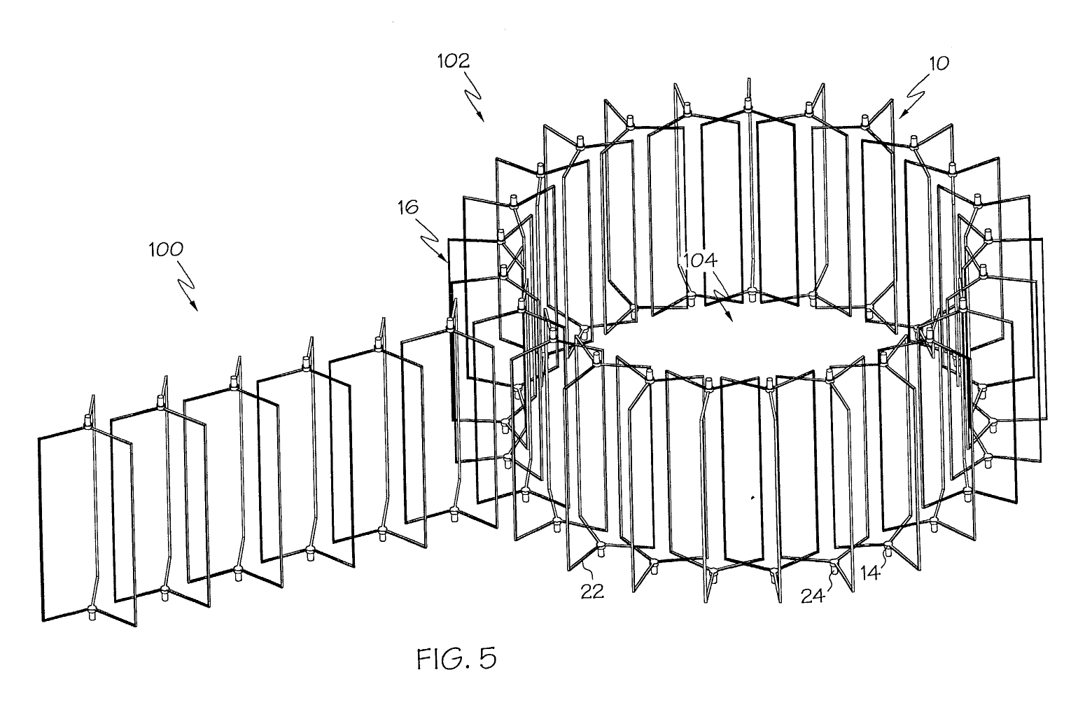

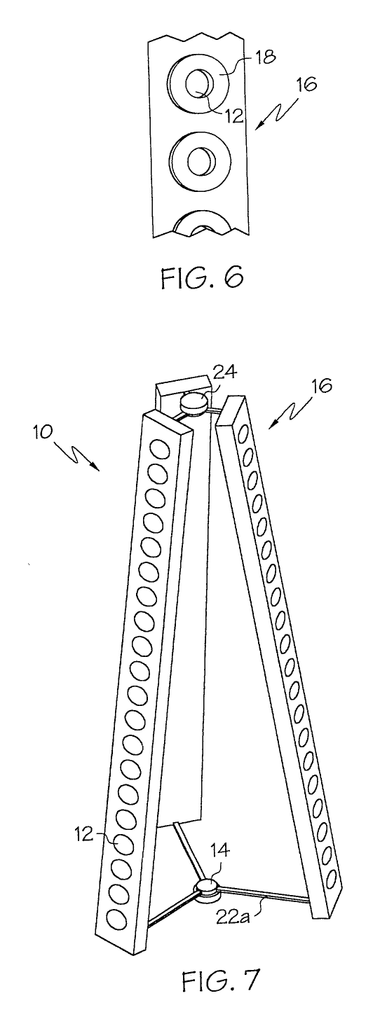

In all of the embodiments of the invention, the LEDs 12 are preferably multicolored and may include a predetermined quantity of red, blue, green, white, amber, and/or other colors of LEDs respectively. Different combinations of colors of LED's 12 may be positioned sequentially and/or in sectors within each arm 16. As shown in FIG. 6, in the present embodiment, the individual LEDs are mounted in a recessed reflective mounting culminator or cone 18. The reflective cone 18 increases LED efficiency by focusing the light emitted from the LED 12 in a predetermined direction. The cones 18 may be manually or automatically adjusted to focus, diffuse and/or direct the light emitted from the LED 12 in any manner desired by the user. The cones 18 may also be modular for releasable attachment to the arm 16. By providing the present invention with cones 18 that may be varied in this manner a wide variety of lighting effects are capable of being created by the present invention.

In alternative embodiments of the invention the LEDs 12 themselves may be adjusted in the manner described above. In addition the LEDs 12 may be channel mounted wherein the channel or channels are reflective. The LEDs 12 may be mounted directly upon the surface of the arm 16 and the arm surface may be reflective.

In particularly demanding applications it may also be desirable to protect the LEDs 12 from external conditions such as moisture, wind, physical contact etc. As a result, in any of the embodiments described, the arm 16 may include a transparent protective covering 20 to protect the LEDs 12, cones 18 and the arm 16. Preferably covering 20 is a material which provides for efficient light transmission but which is fairly durable. Covering 20 may also be configured to act as a focusing lens for individual LEDs 12.

In the various embodiments shown in FIGS. 1-5, the arm 16 is shown mounted to a support 22. The support 22 is presently depicted as a pair of single substantially linear members 22a and 22b connecting and supporting both ends of the arm 16. Alternatively, the support 22 could be embodied as only a single support. For example, the display 10 may be equipped with only a bottom support 22a or only a top support 22b and such a single member could be connected to any point of the arm 16, or if desired, or arm 16 may be embodied in a platform or sheet. In yet another embodiment the support 22 may be a solid or porous member extending between members 22a and 22b.

In the embodiments shown in FIGS. 1-5, the arm 16 is shown as extending substantially perpendicular to the horizontal plane of the supports 22a and 22b. However, the arm 16 is not limited to being perpendicular relative to the support 22. It may be desirable to provide the present invention with an arm 16 which extends vertically upward from either the bottom support 22a or top support 22b, at any angle between zero degrees (horizontal) to 90 degrees (vertical) relative to the support 22a. For example, in the embodiment shown in FIG. 7 the individual arms 16 extend upward from the bottom support 22a at an angle sufficient to allow the arms 16 to intersect at a predetermined point above the rotation hub 14.

The rotation hub 14 or base is engaged by a rotation mechanism 24. The rotation mechanism 24 may be any type of apparatus for providing rotational movement, such as an electric motor, a servo motor or similar device. In the present embodiment the rotation mechanism 24 may be integral with the display 10 and extend from the rotation hub 14 or base. Alternatively, the rotation mechanism 24 may be separate from the display 10. In such an embodiment, the rotation hub 14 and rotation mechanism 24 are linked by an intermediate drive member or other torque transmitting device. In the case of a plurality of displays 10 linked together, such as is shown in FIGS. 3-5, the rotation mechanism 24 may be integral or external of the system 100 and may be engaged to a linking system 110 which simultaneously transmits rotational power to the individual displays 10.

In the various embodiments shown, the rotation hub 14 or base provides a contact surface for the support(s) 22 to engage. Alternatively, the support(s) 22 could be directly connected to the rotation mechanism 24. The rotation mechanism 24 provides the rotation hub 14 with a selected speed preferably between 75 and 3000 RPM. Other speeds, both less than and greater than, the preferred range provided may also be used. However, the speed must be sufficient to allow the persistence of vision in a given viewer's eye to perceive the image created by the combination of rotation and selective activation of the LEDs.

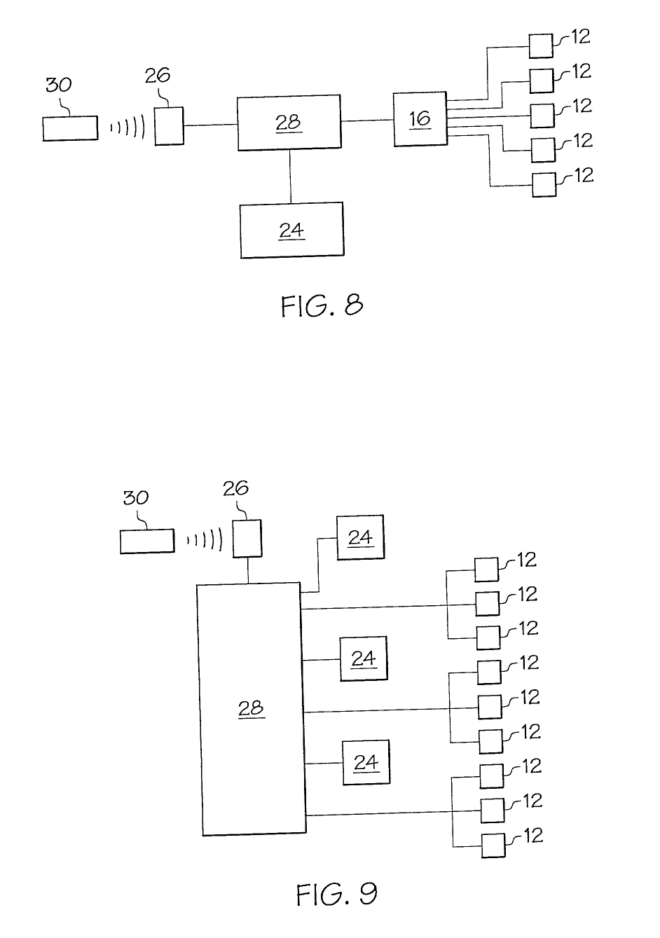

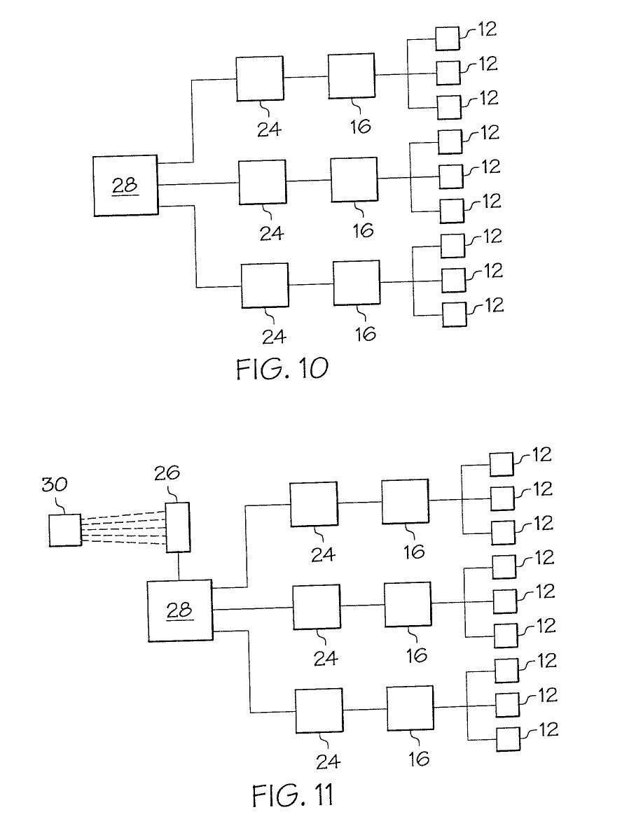

The speed provided by the rotation mechanism 24 as well as the specific sequence in which individual or groups of LEDs are selectively activated are both controlled by a controller 50 such as is depicted in the schematic drawing shown in FIGS. 8-11. The controller 50 may be a processing chip, computer, software package, or a dedicated device having a user interface and which is in electrical communication with the individual LEDs 12 and the rotation mechanism 24. In addition, because it may be desirable to control all of the LEDs 12 of a given arm 16 with a single command, each arm 16 of a display may also be in electronic communication with the controller 50. As a result of the individual communication between each LED 12, arm 16 and rotational mechanism 24, the controller 50 provides the present invention with a tremendous variety of lighting sequences, combinations, patterns, and rotational characteristics for display of a desired visual signal, image, and/or lighting effect.

The controller 50 typically will be integral with a given display system rotational hub 14 or base. However, it may not always be desirable or even possible for a user to readily access the controller 50 for reprogramming. For example, if a display system 100 such as is shown in FIGS. 3-5 were set up to act as a display in a public place such as a stadium it would be undesirable to have a controller 50 which is easily accessed. Where the controller 50 is made difficult to access, the controller may be equipped with an input device 26. The input device 26 is designed to receive and recognize signals from a remote programing unit 30. The input device 26 may be any type of electronic receiver, such as, for example a radio receiver, and optical scanner, an acoustic receiver, etc. Similarly, the remote programing unit 30 may be any type of transmitter such as an optical emitter or other type of remote control device.

The controller 50 of the present invention is capable of providing one or more of the LEDs 12 of the arm 16 with a plurality of lighting sequences, combinations or patterns such that a single image or message may be viewed from 360 degrees about the sign 10 or system 100. The controller 50 is also capable of providing individual or different images in each of multiple actuate viewing sectors of a given display 10. For example, four separate or different images could be respectively provided in four separate arcs of 90 degrees each. Similarly five different images as well as a common image could be respectively provided for five different actuate viewing sectors of 72 degrees each, thus enabling a viewer in one viewing sector to see a collection of images different than those viewed by a given viewer observing the remaining four viewing sectors. One of ordinary skill in the art is able to comprehend that the present invention is capable of producing a wide variety of images in at least an equivalent number of viewing sectors limited only by the processing speed of the controller 50 and the cycling speed of the individual LEDs 12.

In the various FIGS. 3-5 the individual signs 10 are cooperatively used to create an even greater number of images as well as potential viewing sectors. With a plurality of signs 10 such as are shown, a greater variety of images may be created as well as images having a more complex nature. For example in the embodiment shown in FIG. 3, a character message or figure may be illuminated to move or to march about the outer perimeter 102 of the system 100. The larger scale provided by the plurality of displays 10 allows the image or message to be larger and more easily viewed by a viewer.

As may be seen in the various FIGS. 3 and 6, the system 100 may be made to display viewable images on both the inside 104 and the outside 102 perimeters of the system 100. Such inside and outside images may be cooperatively displayed to form complex composite images, which would be difficult to create in a single sign 10. Such a system would be particularly useful for advertising and visual displays in modem stadiums wherein the system 100 could be viewed from 360 degrees simultaneously. The images provided by such a system could be made to have the affect of three dimensions similar to an active hologram.

The systems shown in FIGS. 3-5 may include a controller 50 or controllers which simultaneously control the individual displays 10, rotational mechanisms 24, arms 16 and LEDs 12 of the entire system 100. As a result, a variety of control arrangements may be envisioned for the present invention. Examples of various control arrangements, including the use of input devices 26 and remote programing units 30 are respectively shown in FIGS. 8-11.

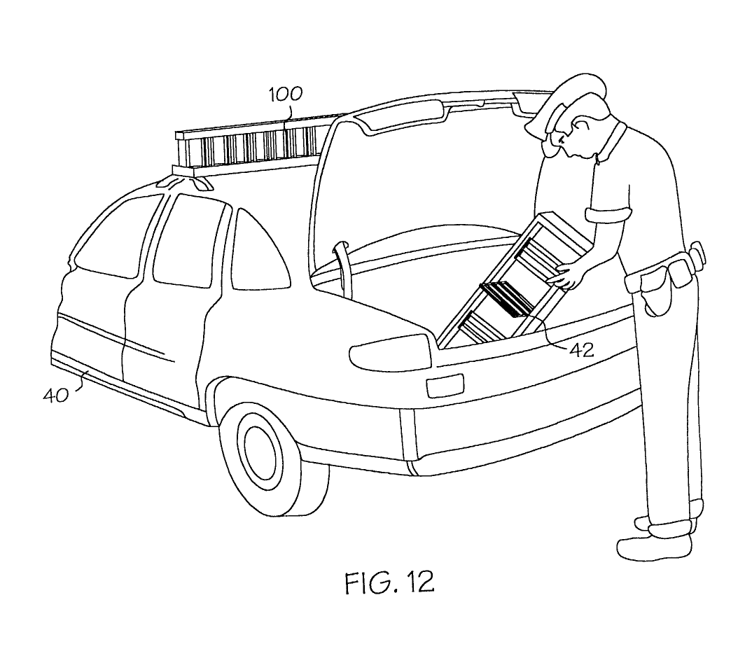

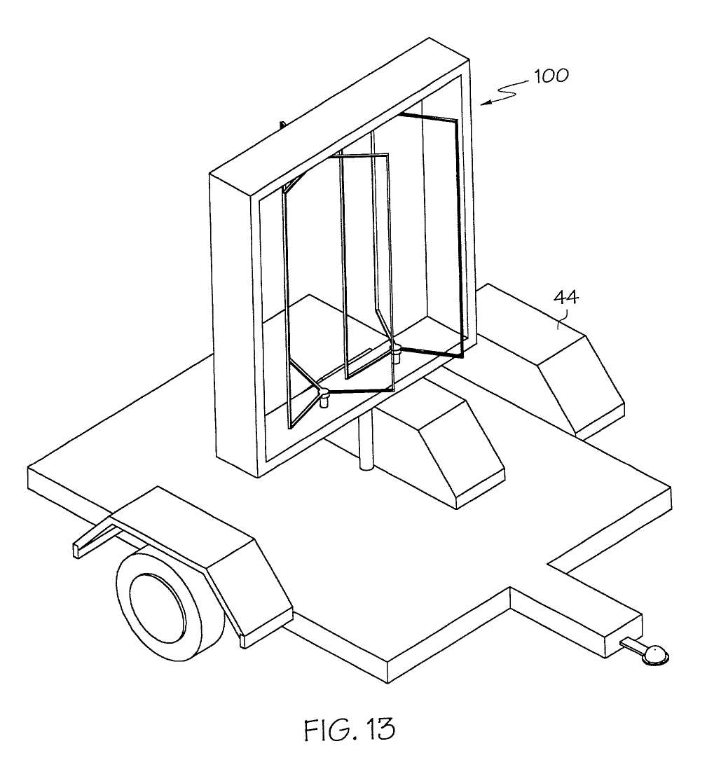

As indicated above, the displays 10 and/or systems 100 of the present invention may be provided for in a variety of configurations. A particularly useful configuration would be to provide a vehicle 40, such as an emergency vehicle, with a system 100, such as is shown in FIG. 11. The vehicle mounted system 100 may be affixed to the vehicle or may be readily removable and have a collapsible or foldable configuration indicated generally at 42. A portable system 42 would allow a user to provide a readily accessible display device which could be utilized in a wide range of applications such as displaying information, providing warnings or other types of notices, provide instruction, etc. Alternatively, as shown in FIG. 12, a larger system 100 could be mounted on a trailer 44 or other vehicle type to provide readily viewable information for a variety of applications.

A need exists for a transportable rotational signaling device assembly which may be conveniently erected and/or disassembled for transportation within a vehicle. Generally, permanent rotatable signs are not aerodynamically efficient, and are not readily repositionable in a desired location for maximization of usefulness. The LED sign 10 herein is provided in a variety of sizes to facilitate usefulness and relocation. In addition, the LED sign 10 herein is aerodynamically efficient and repositionable in any desired location for establishment of a desired lighting effect. The rotation of the mounting arms 16, generally produce significantly reduced aerodynamic drag as compared to the known solid signs of the past. In addition, the LED sign 10 is sufficiently light weight to be a stationary light source or mounted to a vehicle without adversely affecting the operational features as described herein.

A plurality of LED signs 10 as described herein may be used as periodic permanent and/or temporary markers along a roadway. The plurality of LED signs 10 may be electrically and/or optically connected to each other in a series for use in warning motorists of traffic conditions. In addition, a series of optically connected LED signs 10 may be used in law enforcement activities to tag, interrogate, and track motor vehicle license plates as described herein. Further, a known separation distance between adjacent LED signs 10 may be measured for calculating the speed of motor vehicles. Optical communication between adjacent LED signs 10 through SIT-TEL pulsating light signals in conjunction with the SIT-TEL pulsed light tagging of a motor vehicle license plate, may facilitate enforcement of speed limits upon motor ways.

It is anticipated that the controller 50 as identified herein may initiate a signal for an LED sign 10 which may be simultaneously communicated upstream and downstream to adjacent LED signs 10 to change a light signal and/or image for the series of LED signs 10 to perform another desired operation. The almost instantaneous communication of information through a series of LED signs 10 significantly improves safety to motorists reducing risk of motor vehicle accidents. a series of LED signs 10 may also be used to communicate with each other to provide a common or composite image and/or light signal. In addition, a series of LED signs 10 may track or actively search for a motor vehicle through the use of SIT-TEL free space pulsed light transmissions.

Further, the transportable LED sign 10 as described herein has improved flexibility for coupling to a power source. The LED sign 10 may be hard wired to an electrical source; or include a standard three prong connector, and/or an adaptor for insertion into a cigarette lighter receptacle for the provision of power to the LED sign.

The LED sign 10 may be used to create a warning signal for use by an emergency vehicle 40, by selectively activating light sources 12 using controller 50. The LED sign 10 may be used to create a warning signal for use by an emergency vehicle 40, by selectively activating light sources 12 using controller 50. Controller 50 may include a switch which may be manipulated manually, through optical SIT-TEL pulsed light signals, or otherwise for activation of alternative prestored or preprogrammed light images or signals. Alternatively, the controller 50 may coupled to another controller 50 or external controller 55 for the selection of an image or light signal to be transmitted from the LED sign 10.

The controller 50 is used to selectively activate individual LED's 12, to illuminate any number of a plurality of visually distinct types of light signals at any moment; to illuminate more than one of a plurality of visually distinct types of light signals simultaneously at any moment; to illuminate one of a plurality of combinations or patterns of visually distinct light signals at any moment, or over any desired period of time, or to illuminate more than one of a plurality of combinations or patterns of visually distinct light signals over any desired period of time. The plurality of visually distinct light signals may include, but are not necessarily limited to, images, characters, messages, a strobe light signal, a pulsating light signal, an alternating light, a modulated light signal, a variable light signal, a flashing light signal, the illusion of a rotating or an oscillating light signal, a reverse character message, or images such as arrows.

The controller 50 may also incorporate into any selected light signal variable or modulated power intensity to facilitate the provision of a desired unique lighting effect. For example, the controller 50 may illuminate one or more LED light sources 12 to establish a single light signal at a given moment. Alternatively, the controller 50 may illuminate one or more light emitting diode light sources 12 to provide two or more light signals at any given moment. Further, the controller 50 may simultaneously, consecutively, or alternatively, illuminate one or more LED light sources 12 to establish any desired combination or pattern of illuminated visually distinct light signals at any given moment or over a desired period of time. The combination and/or pattern of visually distinct light signals may be random or may be cycled as desired by an individual. The illumination of one or more patterns or combinations of light signals facilitates the continued observation by an individual. Occasionally, the concentration or attention of an individual is diminished when exposed to a repetitive or to a monotonous light signal. The desired purpose for illumination of a light signal is thereby reduced. The provision of a pattern, combination, and/or random illumination of visually distinct light signals maximizes the concentration or attention to be received from an individual observing a light signal. The purpose of the light signal is thereby promoted.

The controller 50 may include a circuit board 346 or LED mounting surface having a microprocessor.

The LED sign 10 may function as a remote, revolving, or stationary beacon. The LED sign 10 may be releasably connected to a transportable support. The transportable support may be a tripod having telescoping legs or may be any other type of support as preferred by an individual. The LED sign may be electrically connected to an elongate electrical extension cable which may include any desired adapter for electrical connection to a power source which may be a vehicle. Plug-in adapters for electrical connection to any desired electrical power source other than a vehicle may also be provided. Alternatively, a portable battery source may be used to supply power to the LED's 12 engaged to the transportable support.

LED light sources 12 may be electrically coupled to a controller 50 which in turn is used to provide a modulated power intensity for the light source. A modulated power intensity enables the provision of various power output or patterns of illumination for creation of a plurality of visually distinct light signals. In these embodiments, the controller 50 illuminates selected LED light sources 12 and the controller 50 may also regulate and/or modulate the power supplied to the light source 12 thereby varying the intensity of the observed light. In addition, the controller 50 may modulate the power supplied to the LED warning signal lamps 12 in accordance with a sine wave pattern having a range of 0 to full intensity. At the instant of fill intensity, the controller 50 may also signal or regulate a power burst for observation by an individual.

The controller 50 may also regulate the modulated power intensity for the provision of a unique variable intensity light signal. The unique variable intensity light source is not required to cycle through a zero intensity phase. It is anticipated that in this embodiment that the range of intensity will cycle from any desired level between zero power to full power. A range of power intensity may be provided between thirty percent to full power and back to thirty percent as regulated by the controller 50. It should also be further noted that an irregular pattern of variable power intensity may be utilized to create a desired type of light effect. In addition, the controller 50 may also sequentially illuminate adjacent LED'S 12 to provide a unique variable rotational, alternating, oscillating, pulsating, flashing, and/or combination variable rotational, alternating, pulsating, oscillating, or flashing visual images, characters, or light effects.

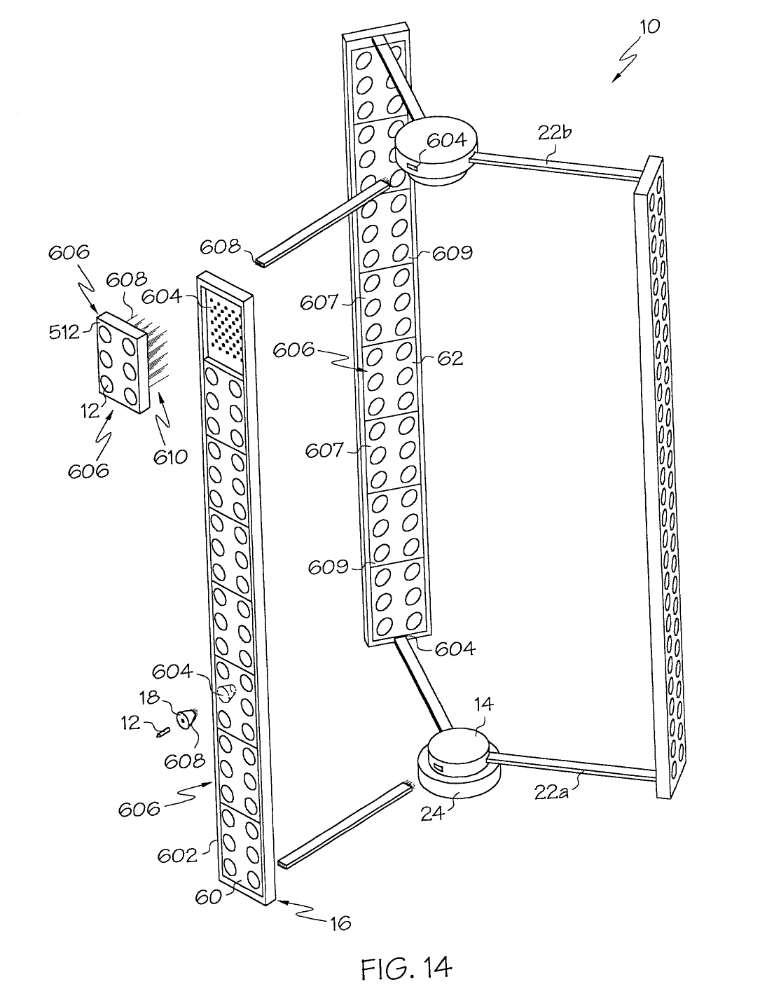

The controller 50 may also be utilized to simultaneously provide modulated or variable light intensity to different and/or independent modules 606, sections, areas, and/or sectors of an LED sign (FIG. 14). Also, the controller 50 may be utilized to simultaneously provide modulated or variable light intensity to different and/or independent modules 606, sectors, areas, and/or sections of the forward facing side 60 or rearward facing side 62 of one or more light bars or arms 16 for the provision of different images, light signals, or light effects on each side of the one or more light bars or arms 16. In this embodiment it is not required that the forward facing 60 and rearward facing sides 62 of the light bars 16 emit the identical images or visual patterns of illuminated light sources 12. The controller 50 may regulate and modulate the variable light intensity of any desired sector or module 606 or combination of sectors of the forward facing side 60 independently from the rearward facing side 62 of the light bars 16. The controller 50 may thereby provide any desired pattern and/or combination of patterns of light signals through the utilization of variable and/or modulated light intensity for the forward facing side 60 or sides, and a different type or set of patterns and/or combination of patterns of light signals having variable or modulated light intensity for the rearward facing side 62 or sides of the light bars 16. The modulated power intensity may be regulated by the controller 50 to create a unique warning light signal within a single sector 606 or in conjunction with multiple separated or adjacent sectors 606 of light arms 16 for the provision of any desired composite light signal.

The power as regulated by controller 50 is not required to be regularly incrementally increased, decreased or terminated. It is anticipated that any pulsating and/or modulated variable light intensity may be provided by the controller 50 to the LED light sources 12. For example, light arms 16 may be separated into one or more distinct segments 606 which are formed of one or more LED light sources 12. A particular segment 606 may be selected as a central illumination band which may receive the greatest exposure to the modulated or variable power intensity and, therefore, provide the brightest observable light signal. An adjacent segment 607 may be disposed on each side of the central illumination band 606 which in turn may receive modulated or variable power intensity of reduced magnitude as compared to the central illumination band 606. A pair of removed segments 609 may be adjacent and exterior to the segments 607, and in turn, may receive exposure to a modulated power source of reduced intensity as compared to segments 607. The number of desired segments may naturally vary. The controller 50 may also provide for the random generation of light signals within a particular segment 606 without the use of a preset or preprogrammed pattern. The use of modular light supports 606 within the mounting arms 16 facilitates the ease of and/or modification and/or the versatile alternative and/or configurations for the LED sign 10.

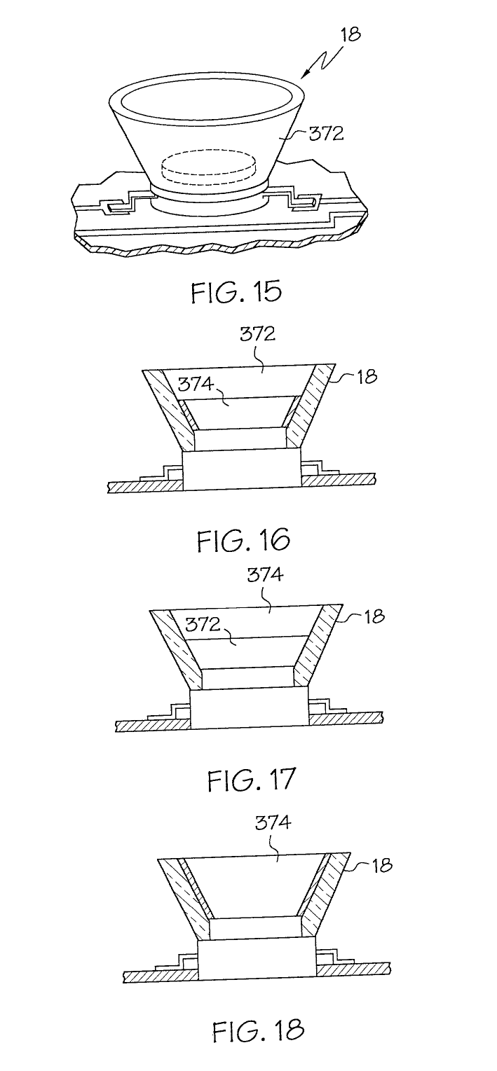

Referring to FIGS. 15-18, a reflector or culminator 18 for the individual LED light sources 12 is disclosed. The reflector or culminator 18 may be conical in shape and may be configured to encircle an individual LED light source 12. The reflector or culminator 18 may be partially transparent. The reflectors 18 may be formed of clear sections 372 and/or a reflective sections 374. In FIG. 17, the clear section 372 is preferably positioned proximate to the LED light source 12 and the reflective section 374 is preferably positioned to the top of the reflector 18.

In FIG. 16, the reflective section 374 is preferably positioned proximate to the LED light source 12 and the clear section 372 is preferably positioned to the top of reflector or culminator 18. As may be seen in FIG. 18, the entire interior surface of the reflector or culminator 18 may be formed of a reflective section 374. It should be noted that any combination of clear sections 372 and reflective sections 374 and any number of clear sections 374 and reflective sections 374 may be utilized within each reflector or culminator 18.

The use of a combination of clear sections 372 and reflective sections 374 enable an individual to select a configuration for the provision of partial illumination along an angle which is not parallel to a desired line of sight. An individual may thereby observe an illuminated light signal from the side or top of a light arm 16 as opposed to being aligned with a desired line of sight.

Each of the culminator or reflector cups 18 preferably include an angled interior surface which extends upwardly and diverges outwardly from a central opening 394. Each central opening 394 is preferably constructed and adapted for positioning approximate to and over an LED light source 12. Each of the culminator or reflector cups 18 also preferably includes an angled exterior surface which extends upwardly and diverges outwardly from a bottom or base which is preferably positioned approximate to an LED mounting surface or circuit board 346.

The interior surface of the culminator cups may be flat, concave, convex, parabolic and/or curved to focus reflected light from the LED illumination sources 12 along a desired line of sight.

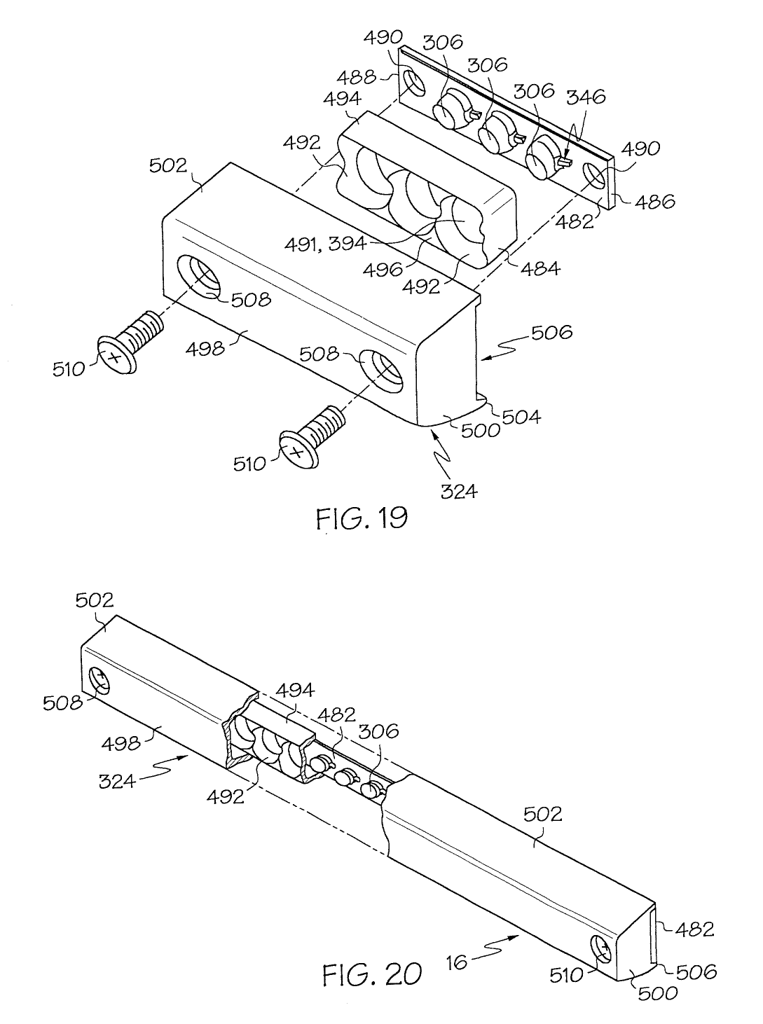

Referring to FIGS. 19 and 20, the LED'S 12 as disposed on each arm 16 may be formed into units 480 which in general include an LED mounting surface 482 having one or more LED light sources 306, a culminator assembly 484 and a cover 324.

The LED mounting surface 482 is preferably elongate and includes a plurality of aligned LED light sources 306. In general, one to five LED light sources 306 are disposed in a linear orientation along the LED mounting surface 482 which may be a circuit board 346 as earlier described. The LED mounting surface 482 also preferably includes a first end 486 and a second end 488. An opening 490 is preferably positioned through the LED mounting surface 482 proximate to each of the first end 486 and second end 488.

The culminator assembly 484 preferably includes a plurality of reflector cup areas 492. The culminator assembly 484 also preferably includes a plurality of support walls 494, a top surface 496, and a plurality of openings 491. Each of the openings 491 is preferably sized to receivingly position and hold the individual LED light source 306 during assembly of the modular light support 480. The reflector cup areas 492 are preferably equally spaced along the culminator assembly 484 to correspond to the spacing between the individual light sources 306 as disposed on the LED mounting surface 482.

The cover 324 is preferably transparent permitting transmission of light emitted from the LED light supports 306 therethrough. The cover 324 includes a forward face 498, a pair of end faces 500, a top face 502 and a bottom face 504. Each of the pair of end faces 500 preferably includes a receiving notch 506 which is adapted to receivingly engage the LED light mounting surface 482 during assembly of the modular unit 480. An affixation opening 508 traverses the forward face 498 proximate to each of the pair of end faces 500. A fastener 510 passes through the affixation opening 508 for engagement to the opening 490 to secure the LED mounting surface 482 into the receiving notch 506. It should be noted that the culminator assembly 484 is then positioned within the interior of the cover 324 where the top surface 496 is proximate to the forward face 498. The illumination of the LED light sources 306 then transmits light through the forward face 498 for observation of a light signal.

Specifically referring to FIG. 20 one or more modular units 480 may be positioned adjacent to each other for the creation of a mounting arm 16. The modular units 480 and/or light bar mounting arm 16 may be coupled to a controller 50 which may independently and/or in combination provide a plurality of independent and visually distinct light signals as earlier described. In addition, the controller 50 may provide modulated and/or variable power intensity to the individual LED light sources 306 to establish any desired light signal effects. It should also be noted that the controller 50 may individually illuminate LED light sources 306 to provide for one or a combination of colored light signals. Any number of modular units 480 may be positioned adjacent to each other to form one or more light bar mounting arms 16.

Turning again to the embodiment shown in FIG. 14. FIG. 14 shows a possible configuration of a mounting arm 16 having replaceable modular components. In this embodiment a light support 602 has a plurality of module receiving ports 604. The module receiving ports 604 are constructed and arranged to provide electrical communication respectively to a module support member 610 of a module 606 received therein. Each of the module support members 610 may be made up of connection teeth or contacts 608 which electrically contact and engage the receiving ports 604 when inserted therein. Each module 606 has at least one visible light signal display surface 612 which has one or more light sources 12 removably mounted thereon. About each light source 12 may be a removable or permanent culminator 18 as earlier described. Culminator 18 more efficiently directs the light emitted from light source 12 in a desired direction. Also, the culminators 18 may also have one or more lenses equipped thereon to provide the signal light with the ability to magnify and/or diffuse emitted light as may be desired.

In the embodiment shown, the module support members 610 and the module receiving ports 604 respectively are uniform in size. The uniformity of the ports 604 and the members 610 allows modules 606 to be readily replaced and also provides the invention with the capacity to have variously sized and shaped modules 606 to be interchanged and arranged in various configurations. For example a relatively elongated module 606, could be positioned in any of the various ports 604 shown and could likewise be replaced with any other longer or shorter module. Such modularity and standardization of connections provides the present invention with a tremendous variety of module configurations which may be readily reconfigured as desired.

It should be understood that modules 606 may be configured in any size or shape as desired. As indicated above, in order to ensure the greatest ease of use and elegance in design, it may be desirable to provide the various modules 606 with uniform support members 610 and also provide the support 602 with similarly uniform ports 604. However, in order to ensure that only certain module types are utilized in certain ports, it is recognized that the present invention could also utilize a support 602 having a variety of port 604 configurations with modules 606 having module supports 610 sized to correspond with specific ports and/or ports 604.

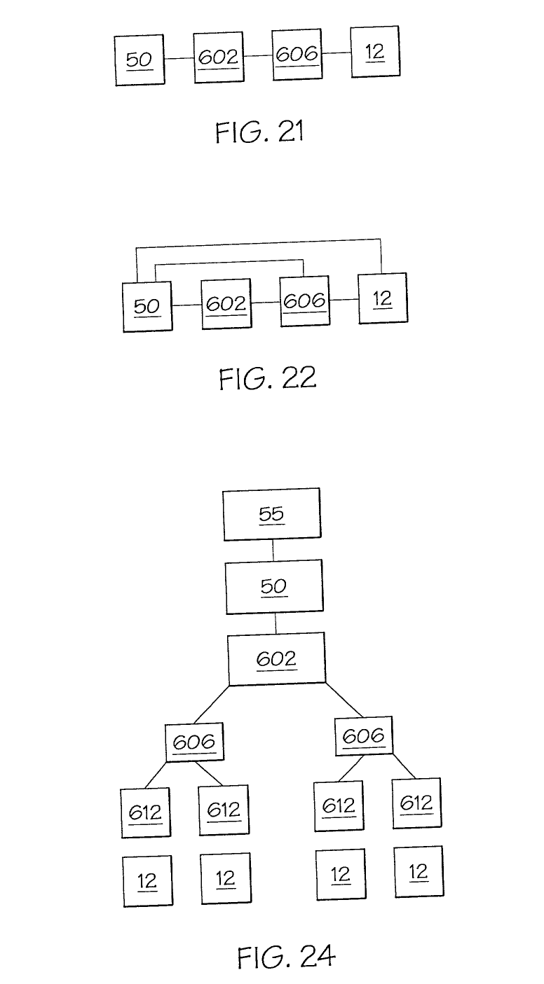

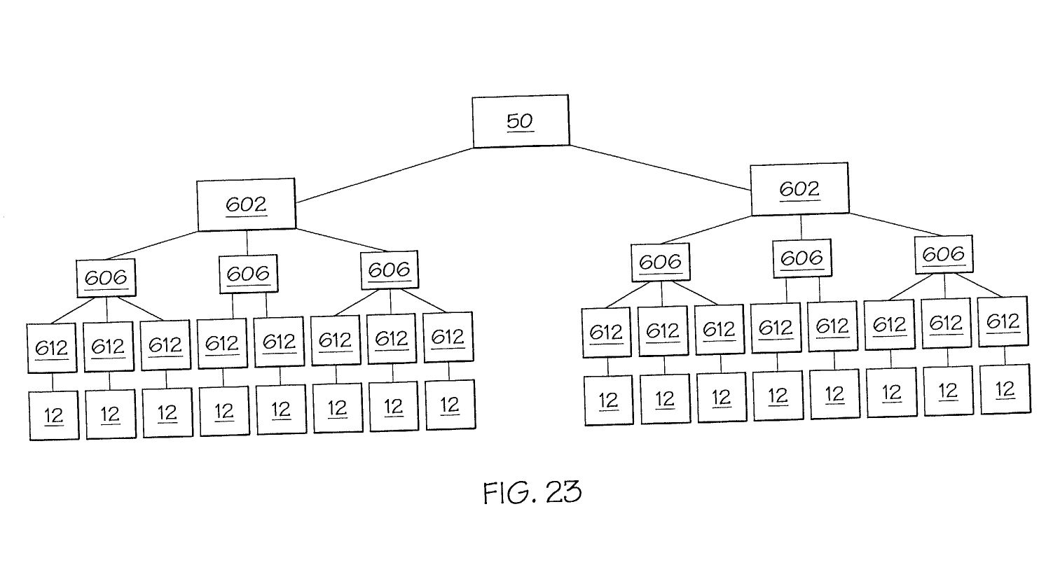

In keeping with the modular construction of the present invention, it should also be understood that the support 602, like most of the components thus described could be embodied in a variety of shapes and sizes. Preferably, the support 602 includes a circuit board 346 with a number of ports 604 included thereon. In one aspect of the invention, the support 602 could be embodied as several supports with each support having a unique arrangement of modules and light sources. The electronic schematics shown in FIGS. 21-24 show some possible configurations and their associated electronic connections between the various components of the invention.

Starting in FIG. 21, an embodiment of the invention is showed where the controller 50 is in electronic communication with one or more supports 602, which are in urn in electronic communication with one or more modules 606, which are in turn in electronic communication with one or more light sources 12. FIG. 53 shows a similar series of electric pathways, but in the present embodiment the controller 50 may also be in direct electric communication with each of the various components, support(s) 602, module(s) 606 and light source(s) 12, independent of one another.

In the embodiment shown in FIG. 24, a support 602 includes a controller 50. Each controller 50 may be in electronic communication with an external controller 55 for reprogramming or communication of information as described herein. The embodiment shown in FIG. 24 may include numerous independently controlled supports 602 which are in communication with the external controller 55. The individual controllers 55 may also be included with each module 606 to provide for a signal light having numerous predetermined individual signals or patterns which may be displayed by sending a single signal from the external controller 55 to the various controllers 50. An external controller 55 may be utilized to store additional patterns of light signals within a memory location such as a storage microchip or EPROM for access by the controller 50. Alternatively, the external controller 55 may reprogram the controller 50 to replace previously stored patterns or combinations of images or light signals. The external controller 55 may be preprogrammed or may be coupled to a central processing unit. The external controller 55 may be disengaged from the central processing unit to function as a transportable remote or hand held reprogramming unit for controller 50. Reprogramming of controller 50 may occur through the use of a connector cable and/or free space communication signals as described herein.

In an alternative embodiment, the rotational hub 14 may be elevated with respect to the roof of a vehicle 40 to enhance visualization during use. The rotational hub 14 may be supported above the roof of a vehicle 40 by a plurality of feet. The feet may be secured to the roof or rain channels through mechanical affixation mechanisms.

One or more LED signs 10 may be connected through a cable and/or pulsed SIT-TEL optical light signals to a digital camera and/or digital recording device. The digital camera preferably converts an image to a digital signal which may be transferred to a controller 50 integral with an LED sign 10. The controller 50 preferably processes the received pattern of digital signals for generation of a pattern of pulsed light signals for illumination of LED light sources 12 in conjunction with rotation of the mounting arms 16. The received digital signals from the digital camera are processed by the controller 50 for display as images by the LED sign 10. Alternatively, the communication of digital signals from the digital camera to the controller 50 may occur through the use of SIT-TEL pulsed light signals. Naturally, SIT-TEL transmitted signals are received by an optical receiver connected to controller 50. The regeneration of images recorded by a digital camera permits the LED sign 10 to be used as a real-time, or delayed, large scale display of images, as an instant replay device, or as a holographic display of images to be observed by individuals.

In an alternative embodiment, an LED sign 10 having at least one LED illumination source 12 may simultaneously produce and emit an observable image or light signal and a SIT-TEL pulsated light signal as a portion of the observable light signal where the SIT-TEL pulsed light signal is not visible to an unaided eye. Generally, the LED'S 12 of the mounting arm 16 are flashing according to a pattern as regulated by the controller 50. The flashing of LED'S 12 as regulated by the controller 50 preferably occurs as a rate which may be detected by unaided observation by an individual. In general, the human eye and mind does not have the capability to recognize flashing light signals where the flashing occurs faster than a give rate. The signal flashing speed which occurs at a rate faster than detectable by an unaided eye appears to be continuous. The controller 50 is preferably constructed and arranged to flash and/or pulse the individual LED light sources 12 at a rate which is unobservable to the human eye. The regulation of pulsation of the individual LED light sources 12 may therefore include SIT-TEL information transmission features to communicate packets of information such as encoded and/or bar coded signals. Therefore, each flash as observed by an individual may include a packet of an encoded pulsed SIT-TEL communication signal as generated by the controller 50. The SIT-TEL pulsed light signal functions as an free space carrier of information for processing by a receiver unit. The SIT-TEL pulsed light signal may also be used independently and not be incorporated as a non-distinguishable component of a light signal. In this instance the SIT-TEL pulsated light signal appears as a continuous light source.

Light emitting diodes 12 may be manufactured to emit light at any wavelength from infrared to visible. Therefore, an infinite variety of colors of different wavelengths of LED's 12 are available. LED's 12 also are extremely flexible in the provision of an instantaneous light signal which minimizes and/or eliminates carry over illumination after termination of power. For example, the application of power to a traditional light source frequently causes electrons to pass through a filament which in turn causes the temperature of the filament to increase emitting the visible light. The termination of power to a traditional light source having a filament does not immediately terminate the provision of light. A carry over illumination effect continues as the traditional light source filament cools. The traditional light source filament therefore is not flexible for receipt of a vary rapid pulsed power for transmission of a pulsed light signal.

An LED light source 12 however is well adapted to receive a rapid pulsed power supply for the provision of a pulsed light signal. In fact, LED's 12 have the capability to pulse thousands of times per second where the rapid pulses are unobservable to an unaided human eye.

The embodiment incorporating the LED sign and SIT-TEL communication system preferably includes a controller 50 having a rapid switch to enable the rapid pulsation of electrical current to the LED light sources 12 which in turn causes the provision of a pulsating light. Simultaneously, the controller 50 may also regulate an observable light signal for illumination in minutes, seconds, and/or fractions of seconds to provide a desired type of unique image or light effect. The pulsated light signals from the controller 50 may function as a means for free space communication of information particularly in substitution for radio frequency transmissions. The use of pulsed LED free space light communication signals eliminates the necessity for expensive cable, wire, and/or fiber optic communication devices and the corresponding infrastructure associated with traditional forms of communication.

LED'S 12 as integral to the mounting arms 16 may be organized into sectors of specific wavelengths of light to be used for SIT-TEL communication signals. The controller 50 may therefore generate SIT-TEL, light signals from one or more of a plurality of sectors dependent upon a desired wavelength of light to be received by a remote receiver location. The LED'S 12 may also be provided at a wavelength of non-visible light for communication of SIT-TEL communication signals.

The image or signal light and SIT-TEL pulsed light signal may be emitted from the first LED light sources 12 simultaneously and/or independently of each other. Variable power may also be applied to the first LED light sources 12 through the controller 50. In addition, the same types and/or combinations of types of light signals whether image light signals and/or SIT-TEL pulsated light signals may be provided simultaneously and/or independently of each other within different sectors of the mounting arm 16.

The controller 50 preferably pulsates the LED light sources 12 at an approximate rate of 1000 pulses per second. The rapid rate of pulsation for the LED light sources 12, may provide for transmission of a significant volume of information to be received by a second controller 826. Naturally, a sufficient number of second receivers 822 may be required to receive all transmitted information dependent on the number wave lengths of light signals utilized. It may also be preferable to have the number of second receivers 822 equal to or exceed the number of wavelength channels utilized by the first LED illumination sources 12 for transmission of information.

The LED sign 10 may also include a first receiver 818 which is electrically coupled to a converter 820. The converter 820 is preferably coupled to the controller 50. The first receiver 818 is capable of recognizing and receiving a SIT-TEL pulsed light signals which may be transmitted either as a directional and/or nondirectional pulsated light. The operational range for the first receiver 818 and the first LED illumination sources 12 is dependent upon the environmental conditions such as humidity, air pressure, air temperature, and pollution factors. It is anticipated that in good environmental conditions that the effective operational range of the first receiver 818 and first LED illumination sources 12 will exceed one half mile and extend to three miles or more.

The first receiver 818 is constructed and arranged to receiver SIT-TEL LED pulsed light signals as generated by a second transmitter of independent LED illumination source(s) 828 having a recognizable wavelength. The received SIT-TEL LED pulsated light signal is converted into a digital signal by a converter 820 for communication to the controller 50. The controller 50 receives the converted digital signal for processing and extraction of transmitted information to respond to an interrogation or information transmission request. The controller 50 continues to process the received digital signal for preparation of an appropriate responsive signal. The controller 50 then communicates the responsive signal to the converter 820 which in turn converts the responsive signal to a series of pulses for transmission from the LED illumination sources 12 as a responsive pulsed SIT-TEL LED optical free space communication signal.

The responsive SIT-TEL LED pulsed light signal in turn is received by a second receiver 822 as coupled to a second converter 824, second controller 826, and second LED illumination device 828. The second receiver 822, second converter 824, and the second controller 826 proceed to translate and process the SIT-TEL pulsed light signal containing communications which originated from the first controller 50.

The first controller 50 and the LED individual light sources 12 as well as the second controller 826 and second LED illumination sources 828 are constructed and arranged to regulate the transmission of an infinite variety of SIT-TEL pulsed LED free space optical light signals. The types of SIT-TEL LED pulsed optical light signals may include but are not necessarily limited to pre-stored characters, numbers, words, and/or terms as identified by an assigned combination of long or short pulses or bar code type or form of signal. The illumination sources 12 and the second illumination sources 828 are constructed and arranged to emit and/or transmit thousands of pulses of LED light within a time period of approximately one second.

The first and second controllers 50, 826 respectively, may each include a memory having stored software and data files for processing of received SIT-TEL LED pulsed light signals. The memory and available stored data facilitate the immediate and automatic recognition of an environmental condition, parameter, or generation of a prestored SIT-TEL pulsed light response. One example of recognition of an environmental condition or situation is when information is desired from a source having an interrogating or second controller 826 which request, through a SIT-TEL pulsed light signal, the identity and/or status of a first controller 50. The responsive first controller 50 upon receipt of a verified interrogation SIT-TEL signal request, initiates a responsive SIT-TEL LED pulsed light signal to transmit information responsive to the received request. A second example of recognition of an environmental condition and/or situation is when a first receiver 818 encounters a continuously emitted SIT-TEL LED pulsed light signal which may function as a warning to trigger an audible or visual alarm to the first controller 50, to minimize safety risks to individuals.

A first controller 50 and a second controller 826 may each preferably contain software establishing a recognition or handshake protocol for acknowledgment, receipt, and transmission of information optically through free space SIT-TEL LED pulsed light signals. The handshake protocol initiates upon the first receiver 818 acknowledging being tagged, or receiving an initial pulsed SIT-TEL LED light signal from a second controller 826. A responsive signal is then generated by the first controller 50 for transmission to the second receiver 822. An acknowledgment message may be returned by the second controller 826 to the first receiver 818. A preselected pattern of acknowledgments may be interchanged to verify readiness for transmission and receipt of desired information through the transmission of free space pulsed SIT-TEL LED light signals. Following transmission of the requested information and/or data, additional verification and/or acknowledgment transmissions may occur between the first receiver 818 and the second receiver 822 prior to the termination of contact through the use of a sign-off protocol.

The first and second receivers 818, 822 preferably are constructed and arranged to recognize certain wavelengths of incoming pulsed SIT-TEL LED light signals. The first and second receivers 818, 822 may be constructed of a plurality of photo detectors, photo diodes, optical transceivers, and/or photo detecting elements to simultaneously, individually, and/or sequentially receive transmissions of SIT-TEL LED pulsed light signals of differing wavelengths. The first and second controllers 814, 826 respectively may also be coupled to an automatic end/or manual scanner 830 or dial which may be manipulated to tune into a different or desired wavelength of transmitted SIT-TEL LED pulsed light signals.

The first and second receivers 818, 822 are preferably constructed and arranged to independently and/or simultaneously receive directional and/or nondirectional pulsed SIT-TEL LED light signals for transmission and communication of information between geographically remote LED illumination sources 12, and 828.

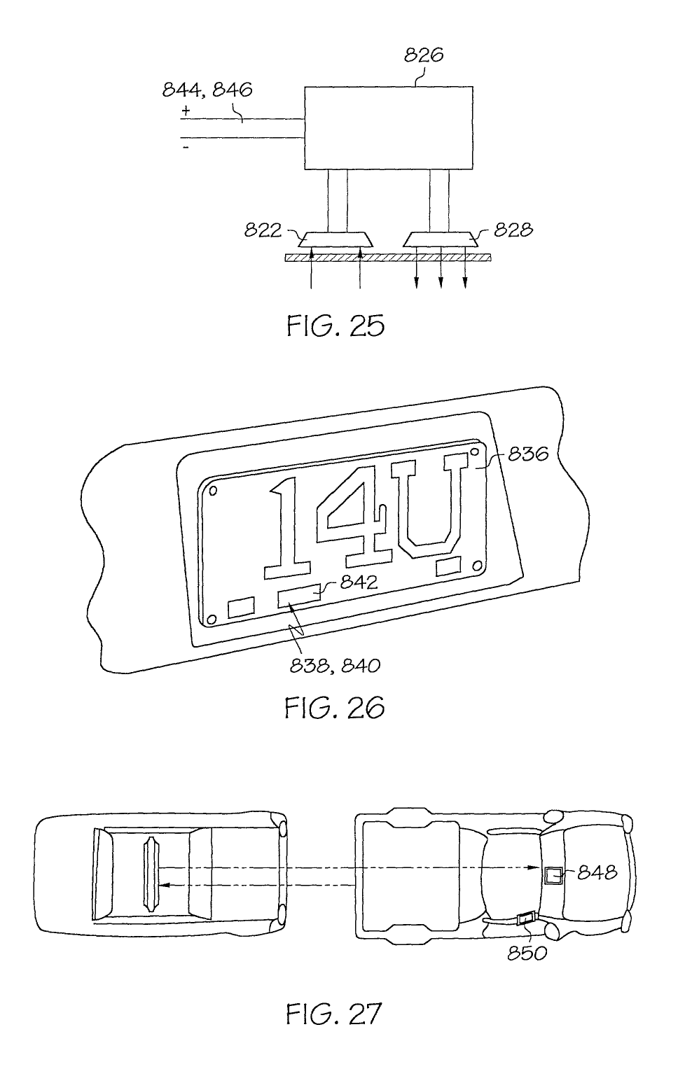

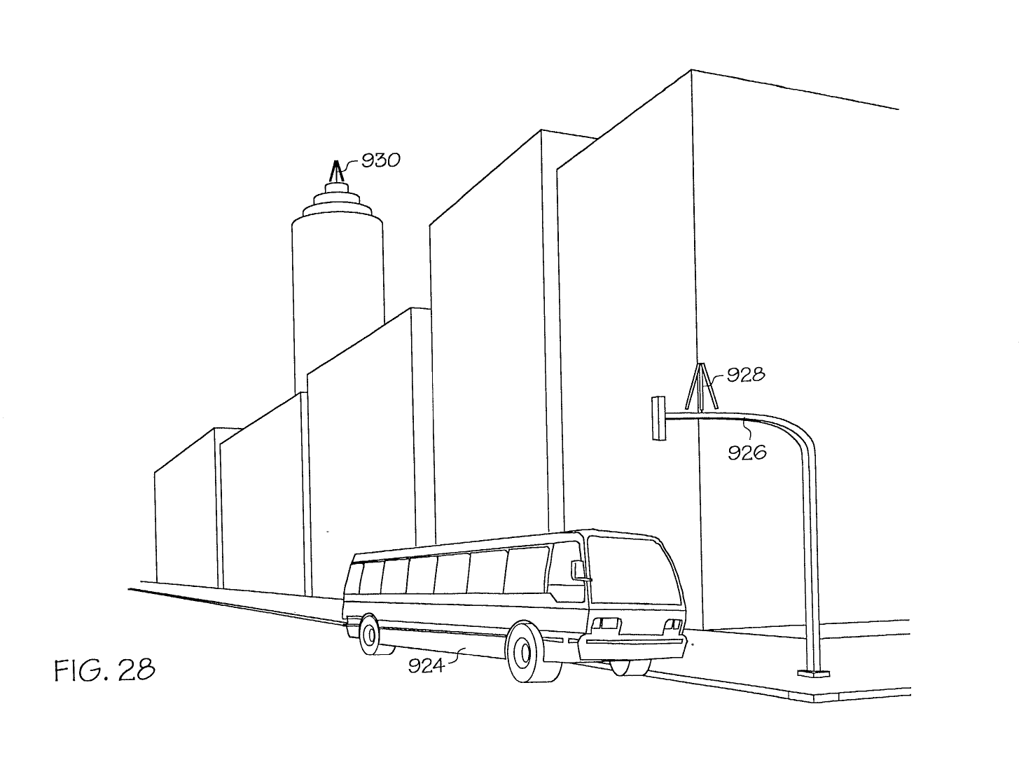

The use of a combination LED sign 10 and pulsated light signal is particularly applicable for use in motor vehicles. During use of the SIT-TEL communications system, information may be transmitted upon carrier pulsated free space SIT-TEL LED light signals, through the use of the second receiver 822, second controller 826, and second LED illumination devices 828 which in turn may be integral and/or attached to another vehicle. The second receiver 822, second controller 826, and second LED illumination sources 828 may be integral with and/or affixed to a motor vehicle license plate 836. The license plate 836 may include a recessed area 838 or a transmission opening 840 which is adapted to receive the second receiver 822 and the second LED illumination sources 828. A transparent cover 842 preferably traverses the recessed area 838 and/or transmission opening 840 to protect the second receiver 822 and second LED illumination sources 828 from contamination during use of the SIT-TEL pulsated light system. A battery 844 and/or power connector 846 is preferably coupled to the second controller 826 which is located upon the non-exterior face of the license plate 836. The battery 844 may preferably be a lithium battery having an approximate life span of five years. Alternatively, the battery 844 may be rechargeable through the use of solar powered cells or other electrical source. Further, the power connector 846 may be coupled to a vehicle electrical system for the provision of power to the second controller 826, second receiver 822, and second LED illumination sources 828. The transparent cover 842 is preferably formed of a sufficiently sturdy transparent material to prevent tampering and/or disconnection of the second receiver 822 or the second LED illumination sources 828. (FIGS. 25 and 26)

The second LED illumination sources 828, second controller 826, and second receiver 822 as integral to the license plate 836 are preferably conspicuously positioned for interrogation by law enforcement officers within law enforcement vehicles utilizing a SIT-TEL interrogation system of an LED sign 10.

The second controller 826 may additionally be electrically connected to a signaling device 848 which may be attached to the dashboard of the motor vehicle. Alternatively, the signaling device 848 may be wired into a radio for a motor vehicle. The signaling device 848 is preferably constructed and arranged to receive a signal from the second controller 826 during situations in which the second receiver 822 has detected a traffic warning message as generated by a SIT-TEL pulsed LED signal emitted from the LED illumination devices 12 as generated by a controller 50 of the LED sign 10. The signaling device 848 thereby provides a visual and/or audible warning to occupants of a motor vehicle. Alternatively, the signaling device 848 may be coupled and/or electrically connected to the radio of a motor vehicle to provide an interrupt switch. Activation of the interrupt switch may cause termination of radio transmissions in the vehicle. Alternatively, the activation of the interrupt switch may permit activation of a database having pre-recorded oral communications for broadcast over a speaker system of the vehicle to orally advise a driver or passenger as to the presence of an emergency situation necessitating the clearance of a roadway. Alternatively, during periods when a motor vehicle radio has not been activated, the second controller 826 may activate the signaling device 848 to engage a motor vehicle radio for the provision of a audible warning alarm. The second controller 826 may additionally include prerecorded voice recognition messages which may be initiated by the second controller 826 upon receipt of an appropriate signal from the LED illumination devices 12. Alternatively, the signaling device 848 may be constructed to emit a verification buzzing or alarm signal when activated by the second controller 826 to warn an occupant of a motor vehicle as to the existence of an emergency situation.

The second receiver 828 may alternatively be formed of a relatively flat and thin rectangular sensor 850 which may be positioned adjacent to a window within the interior of a motor vehicle. The sensor 850 is preferably electrically connected to both the second controller 826 and the signaling device 848. The sensor 850 is preferably constructed and arranged to receive pulsed SIT-TEL LED optical signals for transfer to the second converter 824 for processing by the second controller 826. The sensor 850 may additionally be constructed and arranged to receive a polarized pulsed SIT-TEL LED light signal as may be reflected by the interior windows of a motor vehicle. The sensor 850 may be placed at any location about a motor vehicle and is not limited to affixation to a license plate 836. The sensor 850 is preferably placed at a location about a motor vehicle which is easily accessible to transmitted directional and/or non-directional pulsed SIT-TEL light emitting diode signals as generated by the LED illumination devices 12.

The LED illumination device 12, first controller 50, first receiver 818, and first converter 820 are generally attached or integral to an LED sign 10. The LED illumination device 12 and first receiver 818 may be attached to LED sign 10 at a central and/or other convenient location. The controller 50 may be positioned to the interior of he rotational hub 14. A power supply such as a battery may be integral to the LED sign 10. Alternatively, power may be provided to the components of the controller 50, first receiver 818, first converter 820, and LED illumination devices 12 through the use of a removable power cord coupled to a receptacle such as a cigarette lighter or may be hardwired to the electrical system of a vehicle. The low voltage requirements for the pulsed SIT-TEL LED signaling system does not adversely affect the power parameters for a vehicle. The vehicle may also include a switch 862 disposed at a convenient location for activation of the pulsed SIT-TEL LED signaling and/or interrogation system. A scanner may also be coupled to the controller 50 to facilitate recognition of the wavelength of the pulsed SIT-TEL LED light communication/interrogation signal.

A selection switch may also be coupled to the controller 50 to regulate the emission of focused optics and/or wide angle directional or non-directional pulsed SIT-TEL LED light signals from the LED light sources 12. A wavelength switch may also be coupled to the controller 50 to enable adjustment or change to the wavelength of emitted pulsed SIT-TEL LED light signals. An officer and/or law enforcement personnel may therefore select from an almost infinite variety of visible and/or non-visible light signals. The controller 50 may also be electrically connected to a terminal 870 within an emergency vehicle and/or police squad automobile to visually generate information observable on a screen or display.

The first and second controllers 50, 826 may include a database having pre-stored combinations of long and short pulses representative of images, terms, characters, and/or numbers for communication of information through transmissions of pulsed light signals.

A SIT-TEL pulsed light signal may be used independently and/or in combination with an observable light signal as generated by an LED sign 10 to supplement awareness of an emergency situation. Law enforcement and/or emergency vehicles frequently activate warning lights and sirens to warn motorists as to the existence of an emergency situation. Over the years, the decibel volume of the sirens has increased due to the use of increased applied power. In the past, sirens have been operated through use of approximately 68 watts of power. The amount of applied power to sirens has significantly increased to 200 to 400 watts. The significant increase in power applied to sirens has been partially in response to the manufacture of quieter automobile interiors, which has significantly reduced the volume of exterior road noise. In addition, automotive stereo systems have significantly improved in quality, further reducing a motor vehicle occupants ability to hear an emergency siren. Siren volume has increased to a point where unprotected hearing to individuals may cause injury. It is anticipated that in the future the volume of sirens may be required to be reduced, necessitating alternative avenues of communication of information related to the existence of an emergency situation. One solution to improve the recognition of the existence of an emergency situation is to position am LED sign 10 for observation by occupants of a vehicle.

It is anticipated that the LED sign 10 having a SIT-TEL LED pulsed light signal communication system may be used as an interrogation device upon a targeted motor vehicle. The targeted second receiver 828 then preferably generates an electrical signal to the second converter 824 for transfer to the second controller 826. A responsive message is generated by the second controller 828 for transmission by the second LED illumination sources 828. The responsive pulsed light signal will include a recognizable pattern of pulsed SIT-TEL LED light which may not be observable by the unaided eye. The responsive pulsed SIT-TEL LED light signal will therefore transfer basic information such as make, model, license plate number, status of license tab registrations, driving after revocation, and/or expiration of insurance for a tagged and/or interrogated motor vehicle. The responsive SIT-TEL signal received by the first receiver 818 of the LED sign 10 will preferably be processed by the controller 50 for coupling to a database and/or microprocessor integral to a terminal within a police vehicle. Data therefore may be instantaneously retrieved for display to law enforcement personnel related to the likely occupant and/or criminal and/or driving record of the tagged vehicle without the necessity for an officer to close distance to the suspect vehicle to permit unaided observation of the license plate 836. The speed and ease of access to Department of Motor Vehicle information to aid an officer is therefore significantly enhanced. The use of a pulsed SIT-TEL LED light signal as free space carrier of information eliminates the necessity for a law enforcement vehicle to expend significant economic resources for costly optical aids. The selection of directional or nondirectional pulsed SIT-TEL LED signals permits a law enforcement vehicle to interrogate a significant number and/or virtually all motor vehicles on a roadway to search for a stolen car and/or an abduction where time is of the essence to insure safety to an individual. In addition, a passive search may be activated for the pulsed SIT-TEL light communication system to attempt to identify any motor vehicles within a particular class. The pulsed SIT-TEL LED illumination system also provides to law enforcement personnel immediate verification that a correct vehicle has been tagged for interrogation through the issuance of a responsive pulsed SIT-TEL LED light signal.

In an alternative embodiment, the second controller 826 may be electrically coupled to a motor vehicle speedometer. If the motor vehicle exceeds a certain pre-stored speed then the second controller 826 may signal the second LED illumination sources 828 to initially transmit an excessive speed SIT-TEL LED signal to be received by a first receiver 818.

Transportation markers such as road signs and/or mileage signs may be replaced by the LED sign 10 having a pulsed SIT-TEL LED signaling device to communicate information to a motor vehicle particularly with respect to the location of road detour routes.

The LED sign 10 as a portion of the SIT-TEL system may be organized into patterns and/or groups. The SIT-TEL signaling system utilized in association with a plurality of LED signs 10 is designed to facilitate the tracking a vehicle. Tracking is accomplished through the transmission of a pulsed light signal between adjacent LED signs 10 or LED signs which may be in optical communication to each other.

The components, features, and applications as earlier described related to the SIT-TEL LED pulsed light communication system as a component of an LED sign 10 are equally applicable for use in a subway, bus, and/or mass transit application. For convenience, the subway, bus, and/or mass transit vehicle will be identified by the numeral 924. The subway/bus 924, preferably includes the elements as earlier identified and described related to the license plate 836.

A receiver 818, first converter 820, controller 50, and LED illumination sources 12, are preferably constructed and arranged for attachment to a street sign, building, structure, and/or traffic light 926.

In the mass transit application, the second controller 826, as integral to the bus and/or subway 924, preferably includes pre-stored information as to the vehicle identification number, schedule, and vehicle route. The controller 50, as integral to the street sign, building, structure, and/or traffic light 926, preferably includes pre-stored identification information such as a position location relative to a map. Within the subway mass transit application position identifiers 928, may be regularly spaced along a route.

Initially, the second controller 826, will signal initiation of a first SIT-TEL pulsed light communication signal to be transmitted from the second LED illumination sources 828, for detection by the first receivers 818, as integral to a position identifier 928 of a street sign 926. The controller 50, as coupled to the LED street sign 926, will process the received signal for generation of a second SIT-TEL LED pulsed light signal from the LED illumination sources 12, for transfer to a third receiver 930, as connected to a third converter, third controller, and third LED illumination device. The third receiver 930, third controller, and/or third LED illumination device, are preferably elevated with respect to the LED street signs 926, and/or position identifiers 928, in order to receive pulsed LED SIT-TEL light signals from a plurality of position identifiers 928. The third controller may be electrically coupled to a traffic processor which functions as a central processing and tracking location related to SIT-TEL signals received from the third controller. The information initially transmitted by the subway/bus 924, may include a vehicle identification, and route designation. The controller 50, as integral to the position identifier 928, may record the first SIT-TEL signal received from the second controller 826. The controller 50, may then relay the first SIT-TEL signal including vehicle identification information along with additional information such as an identification signal corresponding to a position identifier 928 address and a signal corresponding to the time of transmission of the SIT-TEL signal. The third controller as receiving the first and second SIT-TEL signals may transfer information to the traffic processor which may compare the information to a preset map and/or schedule for transmission of SIT-TEL signals back to the position identifiers 928. The position identifiers 928, as receiving a SIT-TEL signal from the traffic processor may initiate the transmission of an additional SIT-TEL signal for receipt by a plurality of displays as representative of the tracking and/or location of a bus/subway proceeding along a preselected route. Potential passengers waiting for a bus/subway 924, may therefore in real-time track the location of the desired bus/subway 924, by vehicle identification and time.

An urban suburban communication system may also be formed of a plurality of LED signs 928, which each include at least one first receiver 818, at least one first converter 820, at least one controller 50, and at least one set of LED illumination sources 12. The LED signs 928, may be secured to street and/or traffic signals 926, and/or street lamps, buildings, and/or structures. Alternatively, the LED signs 928, may be placed at any desired location within an urban/suburban environment. Any number of LED signs 928, may be used for detection of SIT-TEL communication signals as emitted from the LED illumination sources 12 of the urban suburban communication system.

The LED signs 928, preferably transmit and/or receive SIT-TEL communication signals to, or from, a user site 930, which may be placed upon a dwelling, building, and/or other structure. The user sites 930, preferably include at least one third receiver, at least one third converter, at least one third controller, and at least one set of third LED illumination sources. Any number of relay sites 928, may be sequentially positioned between the urban suburban communication system and the user site 930. Each SIT-TEL communication signal may therefore be passed from LED sign 928 to the next LED sign 928 to for successive transmission to a user site 930. Types of SIT-TEL signals may include, but are not necessarily limited to, mail messages, pictures, photographs, advertisements, communications, news, real-time entertainment, preprogrammed entertainment, civil defense warnings, and/or any other type or form of communication which may be reduce to pulsed and/or encrypted LED light signals. It is anticipated that SIT-TEL communication signals may be used as a supplement or replacement of modes of communication such as mail, e-mail, advertising, billboards, cell phones, telephones, radio, and/or television. A keyboard may be interfaced to any one of the controllers to facilitate selection of a type of signal to be transmitted by SIT-TEL pulsed LED light signals. The keyboard may alternatively be used to generate a custom message or transmission from the controllers. In addition, a mouse, pointer, or pressure or heat sensitive touch pad may be used to select a type of signal to be transmitted from the controllers and LED signs 10.

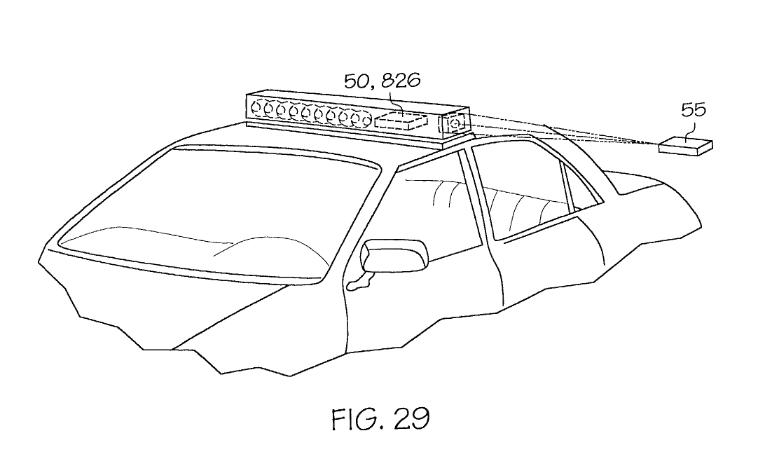

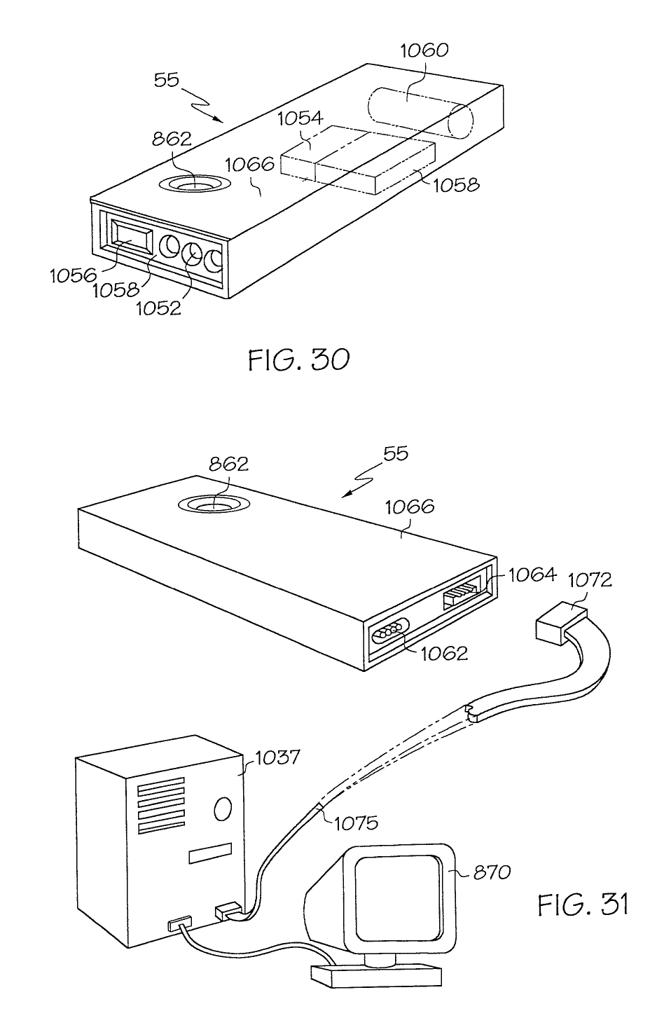

As depicted in FIGS. 29-31, external controller 55 is generally shown for use in reprogramming controller 50, second controller 826, and third controller.

In general, external controller 55 may be sized for convenient hand held transportation having dimensions approximately equal to a standard video/audio remote control. The external controller 55 preferably includes an engagement switch 862, LED light sources 1052, reprogramming controller 1054, light receiver 1056, memory or EPROM 1058, power supply 1060, power supply receiving adaptor 1062, and access port 1064 which may include a USB connection port.

The engagement switch 862 preferably traverses a housing 1066 which is constructed and arranged for convenient manipulation by an individual for activation of the reprogramming controller 1054 and LED light sources 1052 for generation of a SIT-TEL free space pulsed light signal.

A transparent protective cover 1068 is preferably located adjacent to the LED light sources 1052. The transparent protective cover 1068 preferably performs the functions as earlier described related to the LED signs 10.

The light receiver 1056 is preferably positioned adjacent to the LED light sources 1052. The light receiver 1056 is preferably constructed and arranged to receive free space SIT-TEL LED pulsed light signals representative of newly created patterns and/or combinations of images or light signals. Alternatively, the light receiver 1056 is preferably constructed and arranged to receive free space SIT-TEL LED pulsed light signals representative of data to be stored within the memory and/or EPROM 1058. The data may be representative of any combination of pulsed SIT-TEL LED light signals corresponding to information to be transmitted and/or processed through reprogramming controller 1054.

The reprogramming controller 1054, light receiver 1056, memory 1058, power supply 1060, power supply adaptor 1062, LED light sources 1052 and engagement switch 862 are all preferably electrically coupled through the use of a circuit board as earlier described.

The reprogramming controller 1054 is preferably constructed and arranged to generate free space SIT-TEL LED pulsed light signals for receipt by first receiver 818, second receiver 822, and/or third receiver 930 as earlier described related to vehicles, emergency vehicles, utility vehicles, trains, runways, towers, airports, subways, busses, and/or community communication systems.

The external controller 55 preferably includes an internal power source 1060 such as a battery which may be rechargeable as earlier described. Alternatively, the external controller 55 may be electrically coupled to an external power source which may be hardwired and/or transportable through the use of a wire engaged to the power supply receiving adaptor 1062. The access port 1064 is preferably constructed and arranged to receive a connector 1072 which may be a USB connector to couple a central processing unit 1073 to the reprogramming controller 1054 for reprogramming and/or storage of upgraded information such as new images, messages, characters or light signal patterns and/or new SIT-TEL pulsed light signal patterns. The access port 1064 and/or light receiver 1056 are preferably the initial locations for transfer of information to upgrade patterns of pulsed free space SIT-TEL signals and/or images, characters, messages or light signals within external controller 55 having memory 1058. The upgrade information may then be passed through free space pulsed SIT-TEL LED light signals to first, second, and/or third receivers 818, 822, or 930, to reprogram and/or upgrade controllers 50 or 826.

The controller 50, second controller 826, and/or third controller preferably include upgradeable software, which upon receipt of an appropriate SIT-TEL pulsed free space and/or other signal will store a new pattern of LED light signals images, characters, messages or new data representative of stored SIT-TEL free space LED signals.

Alternatively, controller 50, second controller 826, and/or third controller may not include memory or EPROM 1058 having sufficient space to accommodate storage of additional data. In this instance, the external controller 55 and reprogramming controller 1054 may overwrite existing data within controllers 50, second controller 826, and/or third controller with upgraded information representative of new patterns/combinations of light signals, images, characters, messages, and/or new combinations of SIT-TEL pulsed free space communications.

The use of SIT-TEL free space pulsed LED light signals to reprogram controllers 50, second controller 826, and/or third controller eliminates the need to physically couple the controller to a central processing unit such as a laptop computer in order to upgrade stored memory for use of the most current and/or recent available versions of light signal patterns, images, characters, messages, and/or pulsed SIT-TEL LED light signals. The use of an external controller 55 having reprogramable controller 1054 which is transportable as a hand held device permits an individual to eliminate down time by eliminating the necessity for direct coupling of a central processing unit 1073 for transfer of reprogramming data. The hand held external controller 55 preferably reprograms controllers 50, second controller 826, and/or third controller through the use of a pulsed SIT-TEL LED free space communication signal which is transmitted in a reduced amount of time. The SIT-TEL reprogramming signal is activated by manipulating the engagement switch 862 and positioning of the LED light sources 1052 in proximity of the SIT-TEL receivers 818, 822 and/or 930. An individual may therefore walk down a line of LED signs 10 consecutively reprogramming adjacent signs through SIT-TEL free space pulsed light signals significantly reducing time required for reprogramming which would otherwise be required.

The external controller 55 may be coupled to a central processing unit through the use of a cable 1075 for initial transfer and receipt of any necessary software and/or SIT-TEL pulsed light signal upgrades to be transferred to the respective controllers 50, second controller 826, and/or third controller.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims may be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 5 may be taken as alternatively dependent on claim 2, 3 or 4; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

1. A display apparatus comprising:
at least one light bar, the at least one light bar having a predetermined length and an end, the at least one light bar having a plurality of light emitting diodes mounted thereto;
at least one support member, the end of the at least one light bar engaged to the at least one support member;
at least one rotation mechanism, the at least one rotation mechanism engaged to a portion of the at least one support member, the at least one rotation mechanism constructed and arranged to rotate the at least one support member and associated at least one light bar at one or more predetermined rates of rotation; and
a controller, the controller in electrical communication with the plurality of light emitting diodes and the at least one rotation mechanism, the controller regulating the one or more predetermined rates of rotation, the controller providing control for selective illumination of the light emitting diodes to produce at least one image, the at least one image capable of being perceived by a viewer.

2. The display apparatus of claim 1, the controller comprising an input device constructed and arranged to receive a set of instructions.

3. The display apparatus of claim 2, wherein the controller is further constructed and arranged to selectively activate the light emitting diodes to provide the display apparatus with at least one viewable sector, each of the at least one viewable sector defining an visible actuate portion of a 360 degree arc about the display apparatus, whereby the selective activation of the light emitting diodes provides each viewable sector with at least one image, the at least one image displayed in each viewable sector being perceivable from a viewing angel corresponding to the actuate portion of the viewable sector.

4. The display apparatus of claim 3 wherein the at least one viewable sector is selected from within the range of viewable sectors between at least one viewable sector, the at least one viewable sector defining an arc of 360 degrees to at least 360 viewable sectors, each of the 360 viewable sectors defining an arc of 1 degree.

5. The display apparatus of claim 3 wherein the at least one viewable sector is a plurality of viewable sectors.

6. The display apparatus of claim 5 wherein the plurality of viewable sectors are provided with a common image.

7. The display apparatus of claim 4 wherein each of the plurality of viewable sectors is provided with a unique image.

8. The display apparatus of claim 5 wherein each of the plurality of viewable sectors is provided with a plurality of images.

9. The display apparatus of claim 5 wherein each of the plurality of viewable sectors is provided with a plurality of images, at least one of the plurality of images being common to at least two of the plurality of viewable sectors.

10. The display apparatus of claim 5 wherein the plurality of viewable sectors are provided with a plurality of images, at least one of the plurality of images being displayed in a different viewable sector at a predetermined interval of time.

11. The display apparatus of claim 1 the at least one light bar perpendicularly extending from the at least one support member

12. The display apparatus of claim 1 wherein the at least one light bar extends from the at least one support member at an angle between 1 and 90 degrees.

13. The display apparatus of claim 1, the at least one support member further comprises a plurality of support members.

14. The display apparatus of claim 1 wherein the at least one support member is a panel having a predetermined shape.

15. The display apparatus of claim 1, further comprising a plurality of reflective light culminators, each of the plurality of light culminators being partially disposed about each of the plurality of light emitting diodes.

16. The display apparatus of claim 15 wherein the light culminators are constructed and arranged to focus the light emitted by the light emitting diodes.

17. The display apparatus of claim 15 wherein the light culminators are constructed and arranged to diffuse the light emitted by the light emitting diodes.

18. The display apparatus of claim 15 wherein the light are culminators constructed and arranged to direct the light emitted by the light emitting diodes in a predetermined direction.

19. The display apparatus of claim 15 wherein the light culminators are constructed and arranged to adjustably focus, diffuse, direct and any combinations thereof the light emitted from the light emitting diodes.

20. The display apparatus of claim 1 wherein the plurality of light emitting diodes further comprise a predetermined quantity of each red, green, blue, amber, orange, purple, and white light emitting diodes.

21. The display apparatus of claim 2 wherein the input device is a signal receiver.

22. The display apparatus of claim 2, further comprising a remote control, the remote control constructed and arranged to remotely transmit the set of instructions to the input device.

23. The display apparatus of claim 1 wherein at least the at least one light bar, the at least one support member and the at least one rotation member are constructed and arranged to be mounted on a vehicle.

24. The display apparatus of claim 1 wherein at least the at least one light bar, the at least one support member and the at least one rotation member are constructed and arranged to be mounted on a trailer.

25. The display apparatus of claim 1 wherein the display apparatus is characterized as being collapsible.

26. The display apparatus of claim 1 wherein the display apparatus is portable.

27. The display apparatus of claim 1 wherein the plurality of light emitting diodes are arranged on the at least one arm in at least one row and at least one column.

28. The display apparatus of claim 1 wherein the plurality of light emitting diodes mounted to the at least one light bar are in electrical communication with the at least one light bar, the at least one light bar being in electrical communication with the controller.

29. A display apparatus system comprising:
a plurality of display apparatuses, each display apparatus comprising:
at least one light bar, the at least one light bar having a plurality of light emitting diodes mounted thereto;
at least one support member, the at least one light bar engaged to the at least one support member;
a rotation mechanism, the at least one support member being engaged to the rotation mechanism, the rotation mechanism constructed and arranged to rotate the support at one or more rates of rotation; and
a controller, the controller in electrical communication with each of the plurality of display apparatuses, the at least one controller constructed and arranged to control the at least one rate of rotation provided by the rotation mechanism for each of the apparatuses, the controller further constructed and arranged to selectively activate the light emitting diodes to produce at least one image, the at least one image capable of being perceived by a viewer.

30. The system of claim 29, wherein the controller is constructed and arranged to further selectively activate the light emitting diodes of each of the plurality of apparatuses to provide each apparatus with at least one viewable sector, each of the at least one viewable sectors defining a visible actuate portion of a 360 degree arc about each of the apparatus, whereby the selective activation of the light emitting diodes provides each viewable sector with at least one image, the at least one image displayed by each viewable sector being perceivable from a viewing angel corresponding to the actuate portion of the viewable sector.

31. The system of claim 29 wherein the controller selectively and cooperatively activates the light emitting diodes of each of the apparatuses to provide each of the at least one viewable sectors with at least one composite image, a portion of the at least one composite image being produced by each of the plurality of apparatuses.
